(19) United States
(12) Patent Application Publication
(10) Pub. No.: US 2025/0391886 A1
(43) Pub. Date: Dec. 25, 2025

(54) RUTHENIUM-BASED CATALYSTS FOR HYDROGEN FUEL CELLS

(71) Applicant: The Hong Kong University of Science and Technology, Hong Kong (CN)

(72) Inventors: Minhua SHAO, Hong Kong (CN); Guimei LIU, Hong Kong (CN); Yingdan CUI, Fushun (CN)

(21) Appl. No.: 19/189,359

(22) Filed: Apr. 25, 2025

Related U.S. Application Data
(60) Provisional application No. 63/661,586, filed on Jun. 19, 2024.
(60) Provisional application No. 63/664,191, filed on Jun. 26, 2024.

(51) Int. Cl. H01M 4/92; H01M 4/90; H01M 8/083

(52) U.S. Cl. CPC H01M 4/926; H01M 4/9033; H01M 8/083

(57) ABSTRACT

Ruthenium-based catalysts useful for hydrogen oxidation reaction catalysts, the ruthenium-based catalyst including ruthenium and boron disposed on a surface of a boron-doped carbon support, wherein the catalyst does not comprise B⁰; or a ruthenium-based catalyst including ruthenium and VOₓ disposed on a surface of a carbon support, wherein x is 3-4; and electrochemical cells and methods of use thereof.

### CROSS-REFERENCE TO RELATED APPLICATIONS

The present application claims priority from U.S. Provisional Patent Application No. 63/661,586, filed on Jun. 19, 2024, and U.S. Provisional Patent Application No. 63/664,191, filed on Jun. 26, 2024, which are hereby incorporated by reference in their entireties.

### TECHNICAL FIELD

The present disclosure generally relates to electrocatalysts for anion-exchange membrane fuel cells. More particularly, the present disclosure relates to ruthenium-based electrocatalysts comprising vanadium or boron.

### BACKGROUND

Anion-exchange membrane fuel cells (AEMFCs) are becoming more attractive due to the development of non-noble electrocatalysts that exhibit comparable performance to platinum for the oxygen reduction reaction. Such progress has significantly decreased the cost of AEMFCs. However, the sluggish anodic hydrogen oxidation reaction still relies on expensive platinum to obtain desirable performance, which poses a significant challenge for the commercialization of AEMFCs.

In recent years, there has been an increased focus on the development of catalysts using Ru as the primary catalytic active metal site. However, synthetic methods for such Ru-based catalysts is often complex, involving multiple high-temperature reaction steps or vacuum heating conditions. It also involves the use of organic matter, which can lead to toxicity issues and requiring elaborate organic solvent removal steps. Synthesizing highly active Ru-based catalysts without the use of organics is crucial for advancing anion exchange membrane fuel cells toward commercialization.

In other examples, ruthenium has been combined with other metals to optimize the hydrogen binding energy, such as RuPt, Rulr and RuNi. However, hydroxy binding energy of such catalysts can be increased, which can lead to the deactivation of the catalysts at high overpotential by occupation of the active sites for hydrogen species.

Therefore, the introduction of competitive hydroxy adsorption sites could potentially protect the ruthenium sites against deactivation. A solution that allows for the facile preparation of catalysts and achieves a delicate balance between hydrogen binding energy and hydroxy binding energy is urgently needed.

### SUMMARY

The present disclosure provides a platinum-free hydrogen oxidation reaction electrocatalyst generally comprising ruthenium, vanadium, and a carbon support; or ruthenium, boron, and a boron-doped carbon support.

In a first aspect, provided herein is a catalyst comprising ruthenium and boron disposed on a surface of a boron-doped carbon support, wherein the catalyst does not comprise B⁰.

In certain embodiments, the boron is present in the catalyst at 0.71-1.36 wt % relative to a total weight of the catalyst.

In certain embodiments, the ruthenium is present in the catalyst at 16-18 wt % relative to a total weight of the catalyst.

In certain embodiments, the the ruthenium has a hexagonal close-packed (hcp) phase.

In certain embodiments, the catalyst has an average particle size of 2-4.5 nm.

In certain embodiments, the catalyst is prepared according to a method comprising: providing a mixture of RuY₃, H₃BO₃, and a carbon support, wherein Y for each instance is independently a halide, nitrate, phosphate, sulfate, carbonate, or acetate; and annealing the mixture at 500-900° C. thereby forming the catalyst.

In certain embodiments, the mixture is annealed at about 700° C. for about 1 to about 3 hours.

In certain embodiments, boron is present in the catalyst at about 1.09 wt % relative to a total weight of ruthenium, boron, and boron-doped carbon support; ruthenium is present in the catalyst at about 17.33 wt % relative to a total weight of the catalyst; the ruthenium has a hexagonal close-packed (hcp) phase; the catalyst has an average diameter of 2-4.5 nm; the catalyst is prepared according to a method comprising: providing a mixture of RuCl₃, H₃BO₃, and a carbon support; and annealing the mixture at about 700° C. for about 1 to about 3 hours thereby forming the catalyst.

In a second aspect, provided herein is an electrode comprising a base electrode or a substrate, wherein the catalyst described herein is disposed on a surface of the base electrode or the substrate.

In a third aspect, provided herein is an electrochemical cell comprising: the electrode described herein; a counter electrode; and an alkaline electrolyte solution comprising an electrolyte, wherein the electrolyte solution is between and in contact with the electrode and the counter electrode.

In certain embodiments, the electrochemical cell further comprises an anion exchange membrane disposed between the electrode and the counter electrode.

In a fourth aspect, provided herein is a method for generating electricity, the method comprising: introducing a fuel and an oxidant into the alkaline electrolyte solution of the electrochemical cell described herein so as to cause the oxidation of the fuel by the oxidation and thereby generating electricity.

In certain embodiments, the fuel comprises hydrogen and the oxidant comprises oxygen.

In a fifth aspect, provided herein is a catalyst comprising ruthenium and VOₓ disposed on a surface of a carbon support, wherein x is 3-4.

In certain embodiments, ruthenium is present in the catalyst at 8-12 wt % relative to a total weight of the catalyst.

In certain embodiments, vanadium is present in the catalyst at 0.1-2.0 wt % relative to a total weight of the catalyst.

In certain embodiments, the catalyst has an average particle size of about 1.7 nm.

In certain embodiments, the catalyst is prepared according to a method comprising: providing a mixture comprising RuY₃, MVO₃, and the carbon support, wherein Y for each instance is independently a halide, nitrate, phosphate, sulfate, carbonate, or acetate, and M is an ammonium, lithium, sodium, or potassium; contacting the mixture with hydrogen gas at 400-600° C. thereby reducing the mixture and forming the catalyst.

In certain embodiments, the ruthenium is present in the catalyst at 8-12 wt % relative to a total weight of the catalyst; vanadium is present in the catalyst at 0.1-2.0 wt % relative to a total weight of the catalyst; and the catalyst is prepared according to a method comprising: providing a mixture comprising RuY₃, NH₄VO₃, and the carbon support; and contacting the mixture with hydrogen gas at 400-600° C. thereby reducing the mixture and forming the catalyst.

In a sixth aspect, provided herein is an electrode comprising a base electrode or a substrate, wherein the catalyst described herein is disposed on a surface of the base electrode or the substrate.

In a seventh aspect, provided herein is an electrochemical cell comprising: the electrode described herein; a counter electrode; and an alkaline electrolyte solution comprising an electrolyte, wherein the electrolyte solution is between and in contact with the electrode and the counter electrode.

In certain embodiments, the electrochemical cell further comprises an anion exchange membrane disposed between the electrode and the counter electrode.

In an eighth aspect, provided herein is a method for generating electricity, the method comprising: introducing a fuel and an oxidant into the alkaline electrolyte solution of the electrochemical cell described herein so as to cause the oxidation of the fuel by the oxidation and thereby generating electricity.

In certain embodiments, the fuel comprises hydrogen and the oxidant comprises oxygen.

### BRIEF DESCRIPTION OF THE DRAWINGS

The above and other objects and features of the present disclosure will become apparent from the following description of the disclosure, when taken in conjunction with the accompanying drawings.

FIG. 1 shows (A) a plot of current density versus potential, providing the steady-state polarization curves of hydrogen oxidation reaction (HOR) activity for Ru-V/C, Ru/C, V-C and commercial Pt/C. Without mentioned, the current density is in milliamps per square centimeter (mA cm⁻²); potential is in Volts with reference to a reversible hydrogen electrode (V vs RHE); the catalyst loadings were all 10 micrograms per square centimeter (μg cm⁻²); and (B) a plot of exchange current density versus different catalysts, providing the exchange current density normalized with the mass of Ru/Pt (mA mg⁻¹_{PGM}) and the electrochemical surface area (mA cm⁻²_{ECSA}) for Ru-V/C, Ru/C and commercial Pt/C.

FIG. 2 shows (A) is a plot of current density versus potential, providing the steady-state polarization curves of HOR activity for Ru-V/C and Ru/C initially and after 2,000 cycles in 0.1 M KOH electrolyte in the range of 0˜0.5 V; and (B) a plot of current density at 50 mV overpotential versus different catalysts, providing the HOR current density at 50 mV overpotential for Ru-V/C and Ru/C initially and after 2,000 cycles in 0.1 M KOH electrolyte in the range of 0˜0.5 V.

FIG. 3 shows a plot of cell voltage and power density versus current density, providing the polarization curves of anion-exchange membrane fuel cells assembled with 0.1 mg_{PGM} cm⁻² Ru-V/C, Ru/C and commercial Pt/C as anode and 0.4 mg_{PGM} cm⁻² Pt/C as cathode under H₂-O₂ with 0.2 MPa backpressure.

FIG. 4 shows (A) and (B) transmission electron microscopy images of Ru-V/C, and (C) size distribution of the nanoparticles.

FIG. 5 shows an exemplary scheme for the synthesis of the B-Ru/BC catalyst in accordance with certain embodiments described herein.

FIG. 6 TEM images and particle size distribution analysis of Ru/C, Ru/BC, and B-Ru/BC.

FIG. 7 shows structural characterization data of B-Ru/BC and the control group samples. (A) TEM image of B-Ru/BC. (B) Average particle sizes of Ru/C, Ru/BC, and B-Ru/BC. (C, D) EDX elemental mappings (c) and HAADF-STEM image (d) of B-Ru/BC. (E) XRD patterns of Ru/C, Ru/BC, and B-Ru/BC. (f, g) High-resolution XPS spectra of B 1s (F) and Ru 3p (G) in BC, Ru/C, Ru/BC, and B-Ru/BC.

FIG. 8 shows ECSA measurements of PtRu (1:1), Pt/C, B-Ru/BC, Ru/BC and Ru/C by Cu_{UDP} method.

FIG. 9 shows electrochemical characterization of B-Ru/BC, Ru/BC, Ru/C, commercial PtRu/C (1:1) and Pt/C. (A) HOR polarization curves in H₂-saturated 0.1 M KOH at 1600 rpm scanned at 10 mV s⁻¹. (B) Mass activities i_{k,m} derived from (A) and the corresponding Butler-Volmer fitting. (C) Exchange current densities i_{0,s} and i_{0,m}. (D) Mass activities i_{k,m}@0.01 V and i_{k,m}@0.05 V. (E) A comparison of exchange current densities i0,s and i0,m with other reported Ru-based catalysts (mono-PGM). (F) HOR polarization curves at different rotation speeds with the Koutecky-Levich plot.

FIG. 10 shows (A, B) HOR polarization curves of B-Ru/BC samples obtained from different annealing conditions tested in H₂-saturated 0.1 M KOH.

FIG. 11 shows a comparison of the HOR polarization curves of B-Ru/BC samples annealing at 700° C. under different conditions tested in H₂-saturated 0.1 M KOH.

FIG. 12 shows TEM images of the B-Ru/BC-700° C.-3h (A), B-Ru/BC-700° C.-2h-less B doping (B), and B-Ru/BC-700° C.-2h-more B doping (C) samples.

FIG. 13 shows chronoamperometry tests of B-Ru/BC, Pt/C, PtRu/C (1:1) and Ru/C in H₂-saturated 0.1 M KOH at 0.1 V vs RHE.

FIG. 14 shows TEM images of the B-Ru/BC samples before (A) and after (B) the chronoamperometry tests of B-Ru/BC along with the XPS spectra of B 1s (C) and Ru 3p (D) in B-Ru/BC before and after the chronoamperometry tests.

FIG. 15 shows (A-D) CO-tolerance characterization of B-Ru/BC, Ru/C, Pt/C, and PtRu/C (1:1). The HOR curves in solid and in-dash were collected at 1600 rpm scanned at 0.01 V s⁻¹ in H₂-saturated and H₂/CO (1000 ppm)-saturated 0.1 M KOH, respectively. (E) CO-tolerant stability of B-Ru/BC, Ru/C, Pt/C, and PtRu/C (1:1) tested at 1600 rpm at 0.1 V vs RHE.

FIG. 16 shows CO-tolerant stability of B-Ru/BC, Ru/C, Pt/C, and PtRu/C (1:1) in the loading of 10 μg_{PGM} cm⁻² tested at 1600 rpm at 0.1 V vs RHE.

FIG. 17 shows (A) AEMFC performance using B-Ru/BC, Ru/C, Pt/C, and PtRu/C (1:1) anodes. Test condition: cell temperature: 95° C., backpressure: 0.2 MPa for the cell based on B-Ru/BC anode and 0.25 MPa for the other cells, flow rates: 1 L min⁻¹ for H₂ and 2 L min⁻¹ for O₂. (B) Specific peak power calculated based on the PPDs in (A). (C) Durability of AEMFCs using B-Ru/BC anode and Pt/C anode. Test condition: at a constant current density of 0.5 A cm⁻², cell temperature: 80° C., backpressure: 0.15 MPa, flow rates: 0.5 L min⁻¹ for H₂ and 0.5 L min⁻¹ for CO₂-free air. Cathode catalysts are all Pt/C. The loadings are listed in Table 3.

FIG. 18 shows durability of AEMFCs using PtRu/C (1:1) anode. Test condition: at a constant current density of 0.5 A cm⁻², cell temperature: 80° C., backpressure: 0.15 MPa, flow rates: 0.5 L min⁻¹ for H₂ and 0.5 L min⁻¹ for CO₂-free air. Cathode catalysts are all Pt/C. The loadings are listed in Table 3.

FIG. 19 shows AEMFC performance using PtRu/C (2:1) anodes. Test condition: cell temperature: 95° C., backpressure: 0.25 MPa, flow rates: 1 L min⁻¹ for H₂ and 2 L min^{-a}1 for O₂. Cathode catalysts are all Pt/C. The loadings are listed in Table 3.

FIG. 20 shows durability of AEMFCs using PtRu/C (2:1) anode. Test condition: at a constant current density of 0.5 A cm⁻², cell temperature: 80° C., backpressure: 0.1 MPa, flow rates: 0.5 L min⁻¹ for H₂ and 0.5 L min⁻¹ for O₂. Cathode catalysts are all Pt/C. The loadings are listed in Table 3.

FIG. 21 shows the polarization curves of the AEMFC using the B-Ru/BC anode and the Pt/C cathode, both with lower loadings as listed in Table 3.

FIG. 22 shows AEMFC polarization curves in the first 10 cycles using the B-Ru/BC anode (A) and the Pt/C anode (B). Test conditions: cell temperature: 80° C., backpressure: 0.2 MPa, flow rates: 0.8 L min⁻¹ for both H₂ and O₂, RH: 100% for both H₂ and O₂.

FIG. 23 shows Table 1, which presents ICP-MS results of B-Ru/BC, Ru/BC, and Ru/C.

FIG. 24 shows Table 2, which presents i₀ and iₖ of B-Ru/BC samples obtained from different annealing conditions.

FIG. 25 shows Table 3, which presents catalyst loadings of the tested AEMFCs.

FIG. 26 shows Table 4, which presents PGM prices to calculate the specific peak power.

FIG. 27 shows Table 5, which presents a comparison of exchange current densities and mass activities of comparative Ru-based (mono-PGM) alkaline HOR catalysts.

FIG. 28 shows Table 6, which presents a comparison of AEMFC performance using comparative Ru-based anodes.

FIG. 29 shows X-ray diffraction patterns of the Ru/C and Ru-V/C samples.

FIG. 30 shows high-resolution XPS spectra of Ru 3p in Ru-V/C.

FIG. 31 shows high-resolution XPS spectra of V 2p in Ru-V/C.

### DETAILED DESCRIPTION

The terminology used herein is for the purpose of describing particular embodiments only and is not intended to be limiting of the invention. As used herein, the term “and/or” includes any and all combinations of one or more of the associated listed items. As used herein, the singular forms “a”, “an” and “the” are intended to include the plural forms as well as the singular forms, unless the context clearly indicates otherwise. It will be further understood that the terms “comprise” and/or “comprising,” when used in this specification. Specify the presence of stated features, steps, operations, elements, and/or components, but do not preclude the presence or addition of one or more other features, steps, operations, elements, and/or groups thereof.

Unless otherwise defined, all terms (including technical and scientific terms) used herein have the same meaning as commonly understood by one having ordinary skill in the art to which this invention belongs. It will be further understood that terms, such as those defined in commonly used dictionaries, should be interpreted as having a meaning that is consistent with their meaning in the context of the relevant art and the present disclosure and will not be interpreted in an idealized or overly formal sense unless expressly so defined herein.

In describing the invention, it will be understood that a number of techniques and steps are disclosed. Each of these has the individual benefit and each also is used in conjunction with one or more, or in some cases all, of the other disclosed techniques. Accordingly, for the sake of clarity, this description will refrain from repeating every possible combination of the individual steps in an unnecessary fashion. Nevertheless, the specification and claims should be read with the understanding that such combinations are entirely within the scope of the invention and the claims.

Provided herein is a first catalyst comprising ruthenium and boron disposed on a surface of a boron-doped carbon support, wherein the catalyst does not comprise B⁰. In certain embodiments, the first catalyst does not comprise platinum.

The boron in the first catalyst can exist as BO₃³⁻, a conjugate acid selected from the group consisting of HBO₃²⁻, H₂BO₃¹⁻and H₃BO₃ or a mixture thereof. In certain embodiments, the first catalyst comprises boron in the +3 oxidation state.

Boron can be present in the first catalyst at 0.5-2.0 wt %, 0.5-1.9 wt %, 0.5-1.8 wt %, 0.5-1.7 wt %, 0.5-1.6 wt %, 0.5-1.5 wt %, 0.5-1.4 wt %, 0.6-1.4 wt %, 0.7-1.4 wt %, 0.8-1.4 wt %, 0.9-1.4 wt %, 1.0-1.4 wt %, 1.1-1.4 wt %, 1.2-1.4 wt %, 1.3-1.4 wt %, 0.71-1.36 wt %, 1.09-1.36 wt %, 0.71-1.09 wt %, 0.8-1.3 wt %, 0.9-1.2 wt %, 1.0-1.1 wt %, 1.0-1.2 wt %, or 1.05-1.13 wt % relative to a total weight of the first catalyst. In certain embodiments, the boron is present in the first catalyst at about 1.36 wt %, about 1.09 wt %, or about 0.71 wt % relative to a total weight of the first catalyst. In certain embodiments, the boron is present in the first catalyst at about 1.09 wt % relative to a total weight of the first catalyst.

Ruthenium can be present in the first catalyst at 10-20 wt %, 11-20 wt %, 12-20 wt %, 13-20 wt %, 14-20 wt %, 15-20 wt %, 16-20 wt %, 17-20 wt %, 18-20 wt %, 19-20 wt %, 10-19 wt %, 10-18 wt %, 10-17 wt %, 10-16 wt %, 10-15 wt %, 10-14 wt %, 10-13 wt %, 10-12 wt %, 10-11 wt %, 15-19 wt %, 16-18 wt %, 17-18 wt %, 16.52-17.33 wt %, 16.52-17.19 wt %, or 17.19-17.33 wt % relative to a total weight of the catalyst. In certain embodiments, ruthenium is present in the first catalyst at about 16.52 wt %, about 17.19 wt %, or about 17.33 wt % relative to the total weight of the first catalyst. In certain embodiments, ruthenium is present in the first catalyst at about 17.33 wt % relative to the total weight of the first catalyst.

The first catalyst can comprise ruthenium having a hexagonal close-packed (hcp) phase.

The boron-doped carbon support can comprise activated carbon, carbon black, carbon nanotubes, carbon nanohorns, graphene, reduced graphene oxides, C₆₀, carbon aerogel, carbon fiber or cloth, mesoporous carbon, or a mixture thereof. In certain embodiments, the boron-doped carbon support comprises carbon black.

The first catalyst can have an average particle size of 2-5 nm, 2-4.5 nm, 2-4 nm, 2-3.5 nm, 2-3 nm, 2-2.5 nm, 2.5-5 nm, 3-5 nm, 3.5-5 nm, 4-5 nm, 4.5-5 nm, 1.5-4.5 nm, 2-4 nm, 2.5-3.5 nm, or 2.75-3.25 nm. In certain embodiments, the first catalyst has an average particle size of about 2.96 nm.

The first catalyst can be readily prepard according to a method comprising: providing a mixture of RuY₃, H₃BO₃, and a carbon support, wherein Y for each instance is independently a halide, such as chloride, bromide, or iodide, nitrate, phosphate, sulfate, carbonate, acetylacetonate, carbonyl, or acetate; and annealing the mixture at 500-900° C. thereby forming the catalyst. In certain embodiments, RuY₃ is RuCl₃.

In certain embodiments, the method of preparing the first catalyst comprises annealing the mixture at 600-900° C., 700-900° C., 800-900° C., 500-800° C., 500-700° C., 500-600° C., 550-850° C., 600-800° C., 650-750° C., or 675-725° C. In certain embodiments, the method of preparing the first catalyst comprises annealing the mixture at about 700° C.

The method of preparing the first catalyst can comprise annealing the mixture for 30 minutes to 10 hours, 30 minutes to 9 hours, 30 minutes to 8 hours, 30 minutes to 7 hours, 30 minutes to 6 hours, 30 minutes to 5 hours, 30 minutes to 4 hours, 30 minutes to 3 hours, 30 minutes to 2 hours, 30 minutes to 1 hours, 1 hour to 10 hours, 2 hours to 10 hours, 3 hours to 10 hours, 4 hours to 10 hours, 5 hours to 10 hours, 6 hours to 10 hours, 7 hours to 10 hours, 8 hours to 10 hours, 9 hours to 10 hours, 1 hour to 3 hours, 1.5 hours to 2.5 hours, or 1.75 hours to 2.25 hours. In certain embodiments, the method of preparing the first catalyst comprises annealing the mixture for about 2 hours.

The present disclosure also provides a first electrode comprising a base electrode or a substrate and the first catalyst described herein disposed on a surface of the base electrode or the substrate.

In certain embodiments, the base electrode is selected from the group consisting of a glassy carbon electrode, a graphite electrode, an indium tin oxide (ITO) electrode, a fluorine doped tin oxide (FTO) electrode, a carbon paper electrode, a carbon fiber electrode, a polycarbonate track etch (PCTE)-based electrode, and a titanium-based electrode; and the substrate comprises a gas permeable mesh or membrane. In certain embodiments, the base electrode is a glassy carbon electrode.

The first electrode can optionally comprise a binder. The binder may optionally be cured to further bind the first catalyst with the base electrode and can increase the conductivity of electrode. Typical binders include, for example polyvinylidene fluoride (PVDF), alkaline ionomers (such as Sustainion200 XA-9, Sustainion® XC-2 and Sustainion® XB-7), Nafion™M polymer dispersion (such as D520CS, D521CS, D2020CS, and D2021CS), polyvinyl alcohol (PVA), starch, sodium alginate, hydroxypropyl cellulose, carboxymethyl cellulose (CMC), regenerated cellulose, polyvinylpyrrolidone, polyimide, polyamideimide, polyethylene, polypropylene, an ethylene-propylene-diene terpolymer (EPDM), an acrylic resin, a sulfonated EPDM, a styrene-butadiene rubber, polytetrafluoroethylene (PTFE), a polyacrylic polymer, and combinations thereof. In certain embodiments, the binder is Sustainion® XA-9.

The present disclosure also provides a first electrochemical cell comprising: the first electrode described herein; a counter electrode (or counter/reference electrode); optionally a reference electrode (e.g., in a three-electrode system); and an electrolyte solution between and in contact with the first electrode, the counter electrode, and optionally the reference electrode. In certain embodiments, the electrolyte solution comprises an alkaline aqueous solution.

A counter electrode refers to an electrode paired with the electrode described herein, through which passes a current equal in magnitude and opposite in sign to the current passing through the electrode. The counter electrode can include counter electrodes which also function as reference electrodes (i.e., a counter/reference electrode). Any suitable counter electrode known in the art can be used in connection with the methods described herein. For example, the counter electrode can comprise carbon (e.g., highly oriented pyrolytic graphite), a metal [e.g., Al, Au, Ag, Bi, C, Cd, Co, Cr, Cu, Cu alloys (e.g., brass and bronze), Ga, Hg, In, Mo, Nb, Ni, NiC 0204, Ni alloys, Ni-Fe alloys, Pb, Pd alloys, Pt, Pt alloys, Rh, Sn, Sn alloys, Ti, V, W, Zn, or stainless steel], glassy carbon, a conductive polymer, or the like. In certain embodiments, the counter electrode is IrOₓ, RuOₓ, Ir, Pt, or a mixture of IrOₓ and RuOₓ. In certain embodiments, the counter electrode is Pt.

The reference electrode can be selected from a standard hydrogen electrode, calomel electrode, copper-copper (II) sulfate electrode, silver chloride electrode, palladium-hydrogen electrode, mercury-mercurous sulfate electrode, and the like.

The electrolyte solution can comprise a saturated solution of a fuel and an oxidant in the alkaline solution or any concentration below saturation. In certain embodiments, the fuel comprises H2 and the oxidant comprises O₂.

In certain embodiments, the anion exchange membrane includes, but is not limited to, anion exchange membranes sold under the tradenames Sustainion® X-37-50 Grade RT, Sustainion® X-37-50 Grade 60, Sustainion® X-37 Grade FA, Sustainion® X-37 Grade T, Sustainion E-30 Grade T, Sustainion® E-28 Grade T, Sustainion® B-22 Grade T, MTCP-50 (described in Wanjie Song, et al., Alkaline Membranes toward Electrochemical Energy Devices: Recent Development and Future Perspectives ACS Cent. Sci. 2023, 9, 8, 1538-1557 herein incorporated by reference in its entirety), quaternary ammonia poly (N-methyl-piperidine-co-p-terphenyl (QAPPT), and quaternary ammonia poly (ether ether ketone) (QAPEEK). In certain embodiments, the anion exchange membrane is a poly (aryl piperidinium)-based anion exchange membrane (PiperION).

The first electrochemical cell described herein can be used for generating electricity according to a method comprising: introducing a fuel and an oxidant into the alkaline electrolyte solution of the first electrochemical cell so as to cause the oxidation of the fuel by the oxidation and thereby generating electricity. In certain embodiments, the fuel comprises hydrogen and the oxidant comprises oxygen.

The present disclosure further provides a second catalyst ruthenium and VOₓ disposed on a surface of a carbon support, wherein x is 3-4.

As shown in FIG. 33, ruthenium present in the second catalyst can exist as Ru⁰ and Ru²⁺.

The second catalyst can comprise ruthenium having a hcp phase.

Ruthenium can be present in the second catalyst at 8-12 wt %, 9-12 wt %, 10-12 wt %, 11-12 wt %, 8-11 wt %, 8-10 wt %, 8-9 wt %, 9-11 wt %, 9-10 wt %, or 8-10 wt % relative to a total weight of the second catalyst. In certain embodiments, ruthenium is present in the second catalyst at about 10 wt % relative to a total weight of the second catalyst.

Vanadium can be present in the second catalyst at 0.1-2.0 wt %, 0.25-2.0 wt %, 0.5-2.0 wt %, 0.75-2.0 wt %, 1.0-2.0 wt %, 1.25-2.0 wt %, 1.5-2.0 wt %, 1.75-2.0 wt %, 0.1-1.75 wt %, 0.1-1.5 wt %, 0.1-1.25 wt %, 0.1-1.0 wt %, 0.1-0.75 wt %, 0.1-0.5 wt %, 0.1-0.025 wt %, 0.25-1.75 wt %, 0.50-1.50 wt %, 0.75-1.25 wt %, 1.0-1.25 wt %, or 0.75-1.00 wt % relative to the total weight of the second catalyst. In certain embodiments, vanadium is present in the second catalyst at about 1 wt % relative to the total weight of the second catalyst.

The second catalyst can have an average particle size of 1-5 nm, 1-4 nm, 1-3 nm, 1-2 nm, 2-5 nm, 3-5 nm, 4-5 nm, 2-4 nm, 2-3 nm, 3-4 nm 1.0-2.4 nm, 1.1-2.3 nm, 1.2-2.2 nm, 1.3-2.1 nm, 1.4-2.0 nm, 1.5-1.9 nm, or 1.6-1.8 nm. In certain embodiments, the second catalyst has an average particle size of 1.7 nm.

The carbon support can comprise activated carbon, carbon black, carbon nanotubes, carbon nanohorns, graphene, reduced graphene oxides, C₆₀, carbon aerogel, carbon fiber or cloth, mesoporous carbon, or a mixture thereof. In certain embodiments, the carbon support comprises carbon black.

The second catalyst can be readily prepared according to a method comprising: providing a mixture comprising RuY₃, MVO₃, and the carbon support, wherein Y for each instance is independently a halide, nitrate, phosphate, sulfate, carbonate, or acetate, and M is an ammonium, lithium, sodium, or potassium; contacting the mixture with hydrogen gas at 400-600° C. thereby reducing the mixture and forming the second catalyst. In certain embodiments, RuY₃ is RuCl₃. In certain embodiments, MVO₃ is NH₄VO₃.

In certain embodiments, the method of preparing the second catalyst comprises contacting the mixture with hydrogen gas at 450-600° C., 500-600° C., 550-600° C., 400-550° C., 400-500° C., 400-450° C., or 450-550° C. In certain embodiments, the method of preparing the first catalyst comprises contacting the mixture with hydrogen gas at about 500° C.

The present disclosure also provides a second electrode comprising a base electrode or a substrate and the second catalyst described herein disposed on a surface of the base electrode or the substrate.

In certain embodiments, the base electrode is selected from the group consisting of a glassy carbon electrode, a graphite electrode, an indium tin oxide (ITO) electrode, a fluorine doped tin oxide (FTO) electrode, a carbon paper electrode, a carbon fiber electrode, a polycarbonate track etch (PCTE)-based electrode, and a titanium-based electrode; and the substrate comprises a gas permeable mesh or membrane. In certain embodiments, the base electrode is a glassy carbon electrode.

The second electrode can optionally comprise a binder. The binder may optionally be cured to further bind the second catalyst with the base electrode and can increase the conductivity of electrode. Typical binders include, for example polyvinylidene fluoride (PVDF), alkaline ionomers (such as Sustainion® XA-9, Sustainion® XC-2 and Sustainion® XB-7), Nafion™ polymer dispersion (such as D520CS, D521CS, D2020CS, and D2021CS), polyvinyl alcohol (PVA), starch, sodium alginate, hydroxypropyl cellulose, carboxymethyl cellulose (CMC), regenerated cellulose, polyvinylpyrrolidone, polyimide, polyamideimide, polyethylene, polypropylene, an ethylene-propylene-diene terpolymer (EPDM), an acrylic resin, a sulfonated EPDM, a styrene-butadiene rubber, polytetrafluoroethylene (PTFE), a polyacrylic polymer, and combinations thereof. In certain embodiments, the binder is Sustainion® XA-9.

The present disclosure also provides a second electrochemical cell comprising: the second electrode described herein; a counter electrode (or counter/reference electrode); optionally a reference electrode (e.g., in a three-electrode system); and an electrolyte solution between and in contact with the second electrode, the counter electrode, and optionally the reference electrode. In certain embodiments, the electrolyte solution comprises an alkaline aqueous solution.

A counter electrode refers to an electrode paired with the electrode described herein, through which passes a current equal in magnitude and opposite in sign to the current passing through the electrode. The counter electrode can include counter electrodes which also function as reference electrodes (i.e., a counter/reference electrode). Any suitable counter electrode known in the art can be used in connection with the methods described herein. For example, the counter electrode can comprise carbon (e.g., highly oriented pyrolytic graphite), a metal [e.g., Al, Au, Ag, Bi, C, Cd, Co, Cr, Cu, Cu alloys (e.g., brass and bronze), Ga, Hg, In, Mo, Nb, Ni, NiCo₂O₄, Ni alloys, Ni-Fe alloys, Pb, Pd alloys, Pt, Pt alloys, Rh, Sn, Sn alloys, Ti, V, W, Zn, or stainless steel], glassy carbon, a conductive polymer, or the like. In certain embodiments, the counter electrode is IrOₓ, RuOₓ, Ir, Pt, or a mixture of IrOₓ and RuOₓ. In certain embodiments, the counter electrode is Pt.

The reference electrode can be selected from a standard hydrogen electrode, calomel electrode, copper-copper (II) sulfate electrode, silver chloride electrode, palladium-hydrogen electrode, mercury-mercurous sulfate electrode, and the like.

The electrolyte solution can comprise a saturated solution of a fuel and an oxidant in the alkaline solution or any concentration below saturation. In certain embodiments, the fuel comprises H₂ and the oxidant comprises O₂.

In certain embodiments, the anion exchange membrane include be, but is not limited to, anion exchange membranes sold under the tradenames Sustainion® X-37-50 Grade RT, Sustainion® X-37-50 Grade 60, Sustainion® X-37 Grade FA, Sustainion® X-37 Grade T, Sustainion E-30 Grade T, Sustainion® E-28 Grade T, Sustainion® B-22 Grade T, MTCP-50 (described in Wanjie Song, et al., Alkaline Membranes toward Electrochemical Energy Devices: Recent Development and Future Perspectives ACS Cent. Sci. 2023, 9, 8, 1538-1557 herein incorporated by reference in its entirety), quaternary ammonium poly(N-methyl-piperidine-co-p-terphenyl (QAPPT), and quaternary ammonia poly(ether ether ketone) (QAPEEK). In certain embodiments, the anion exchange membrane is a poly(aryl piperidinium)-based anion exchange membrane (PiperION).

The second electrochemical cell described herein can be used for generating electricity according to a method comprising: introducing a fuel and an oxidant into the alkaline electrolyte solution of the second electrochemical cell so as to cause the oxidation of the fuel by the oxidation and thereby generating electricity. In certain embodiments, the fuel comprises hydrogen and the oxidant comprises oxygen.

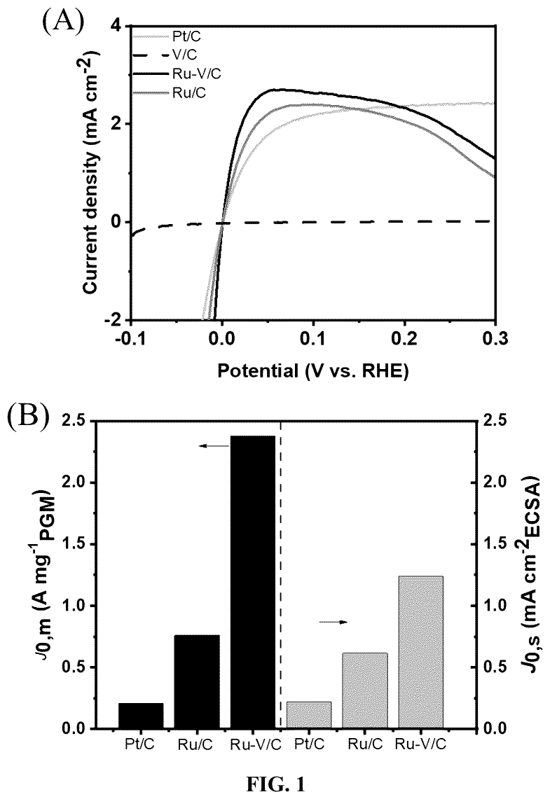

The present invention will now be described by referencing the appended figures representing preferred embodiments. FIG. 1A shows the hydrogen oxidation reaction current density of Ru-V/C, Ru/C, V-C and Pt/C. The current density at 0.05 V overpotential for Ru-V/C is 2.66 mA cm⁻², while the values are 2.2, 1.78, and 0 mA cm⁻² for Ru/C, Pt/C and V/C. An exchange current density of 4.24 mA cm⁻² for Ru-V/C can be obtained, while only 2.8, 1.76 and 0 mA cm⁻2 for Ru/C, Pt/C and V/C.

FIG. 1B demonstrates the exchange current density normalized with mass and electrochemical surface area of Pt/Ru. The mass activity of Ru-V/C is 10 times higher than Pt/C, and 6 times higher than Pt/C in electrochemical surface area activity.

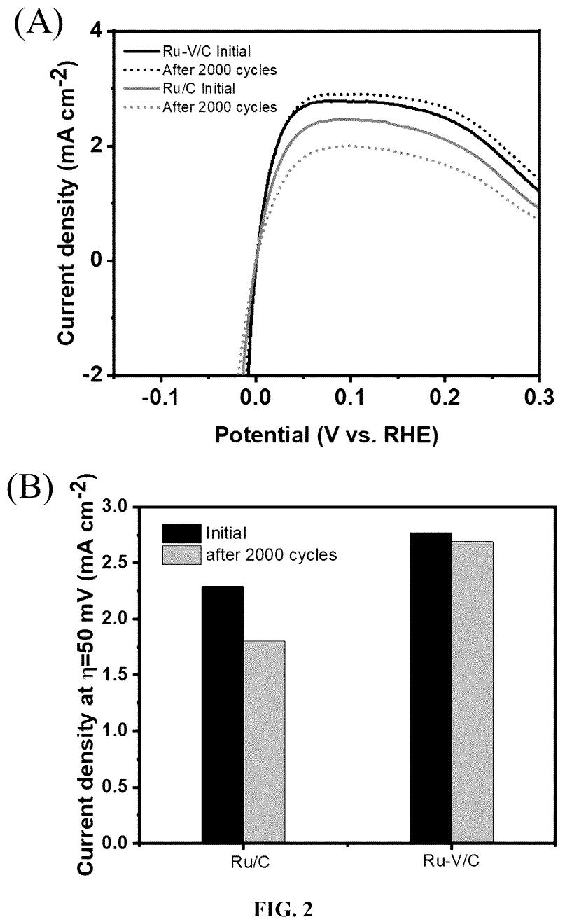

FIG. 2A shows the hydrogen oxidation reaction current density change before and after 2,000 CV cycles between 0˜0.5V. No activity loss can be found after a long-term durability test, suggesting Ru-V/C exhibits robust stability in an alkaline condition.

FIG. 2B shows the hydrogen oxidation reaction current density change before and after 2,000 CV cycles between 0˜0.5V. Only 3% activity drop was found for Ru-V/C while 21% degradation for Ru/C. It proves Ru-V/C is more durable than Ru/C.

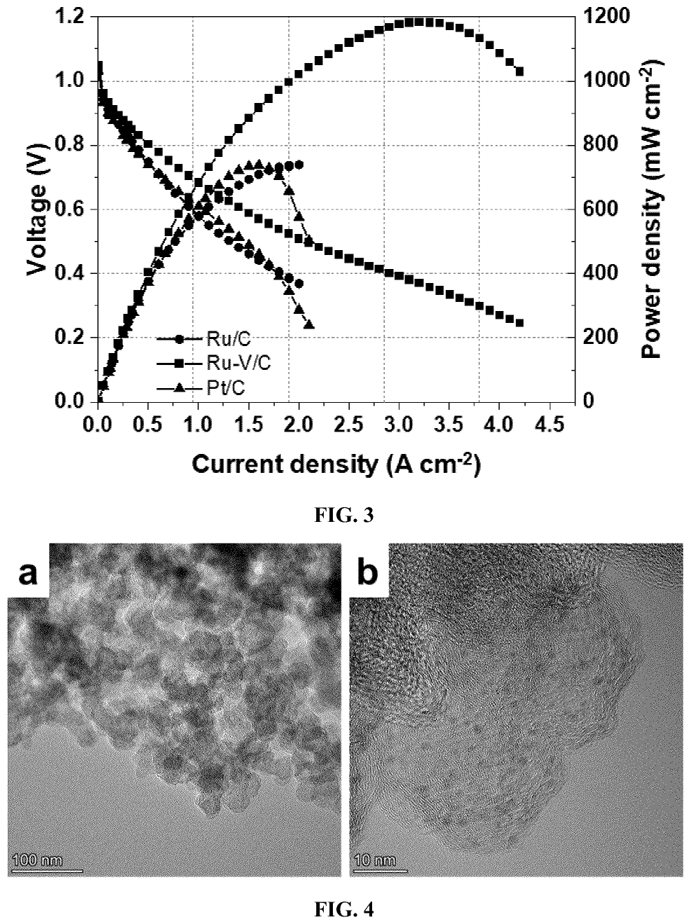

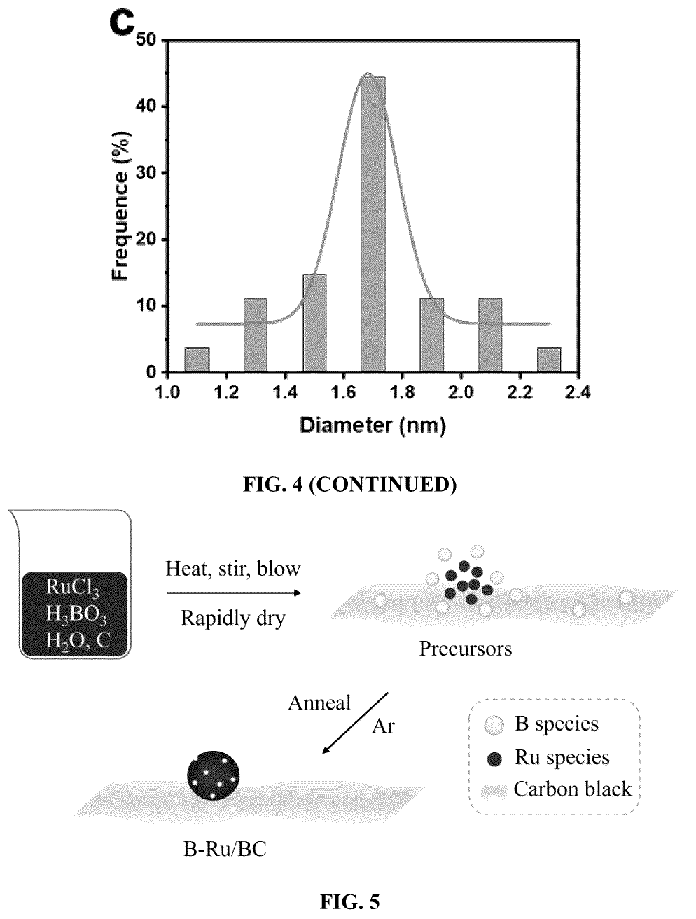

FIG. 3 shows the fuel cell performance with different anodes. Ru-V/C arrived at 1.2 W cm⁻² peak power density, while only 0.74 and 0.73 W cm⁻² for Pt/C and Ru/C. It demonstrates the excellent activity of Ru-V/C.

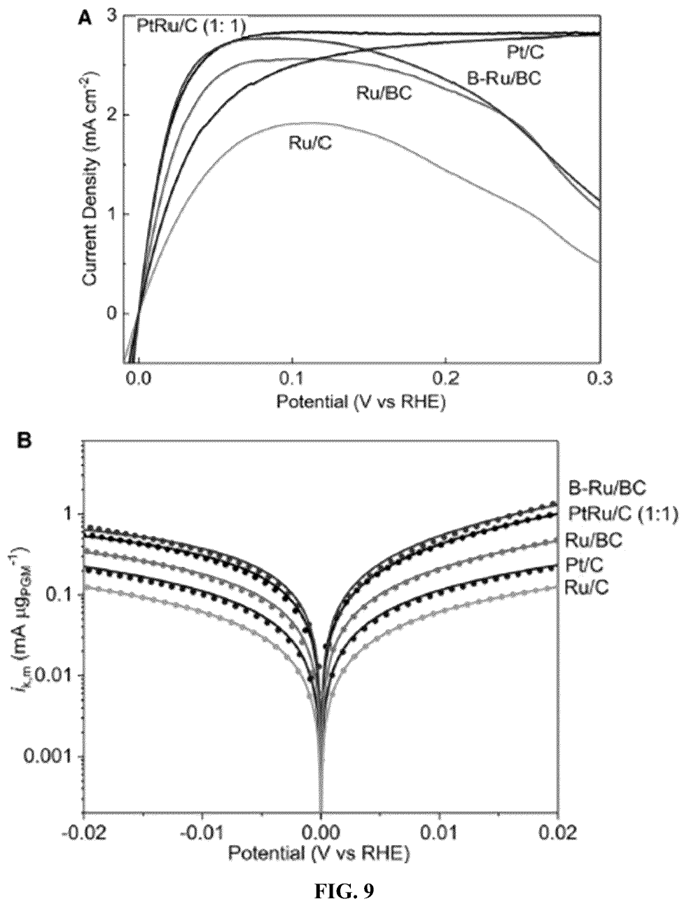

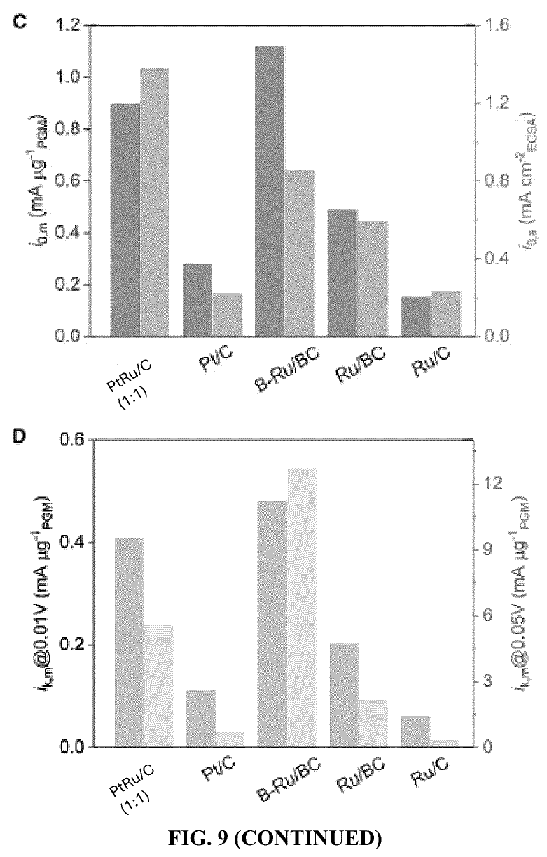

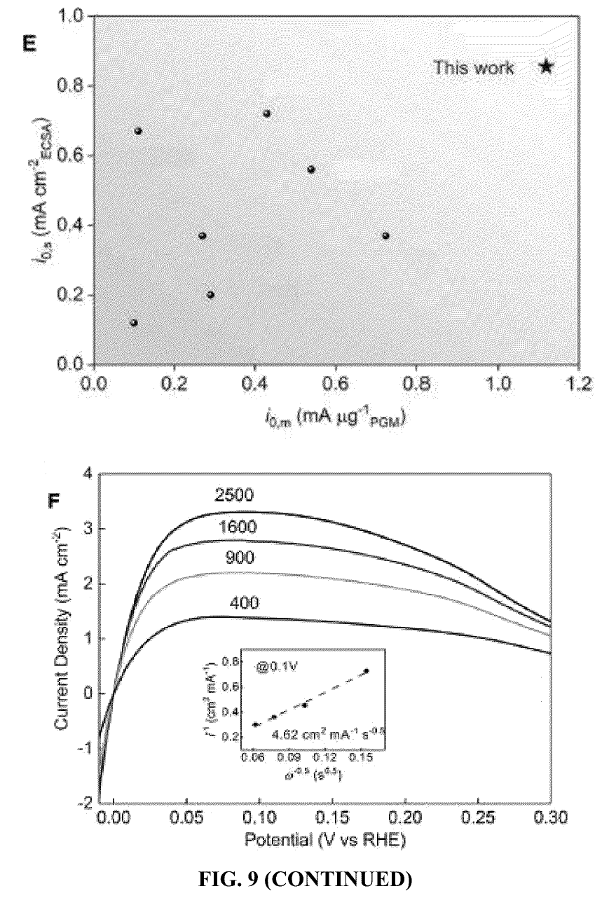

The present invention will now be described by referencing the appended figures representing preferred embodiments. FIG. 9A shows the hydrogen oxidation reaction current density of B-Ru/BC and Pt/C. The current density at 0.05 V overpotential for B-Ru/BC is 2.58 mA cm⁻², while 2.02 mA cm⁻² for Pt/C. A mass-normalized exchange current density of 0.9 A mg_{PGM}⁻¹ was obtained for B-Ru/BC, while only 0.3 A mg_{PGM}⁻¹ for Pt/C. In RDE tests, B-Ru/BC performs higher HOR activity than Pt/C.

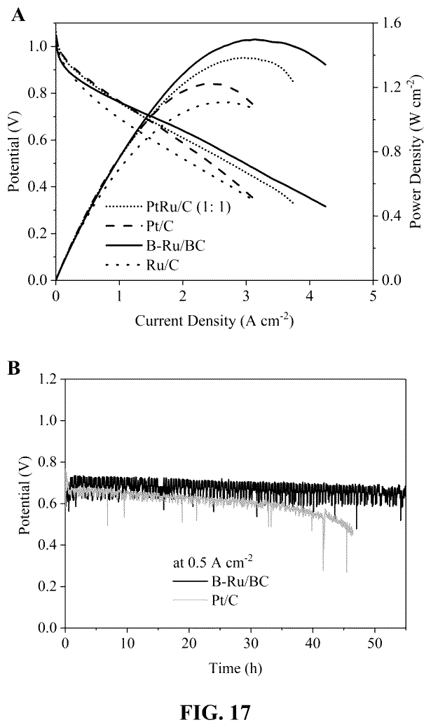

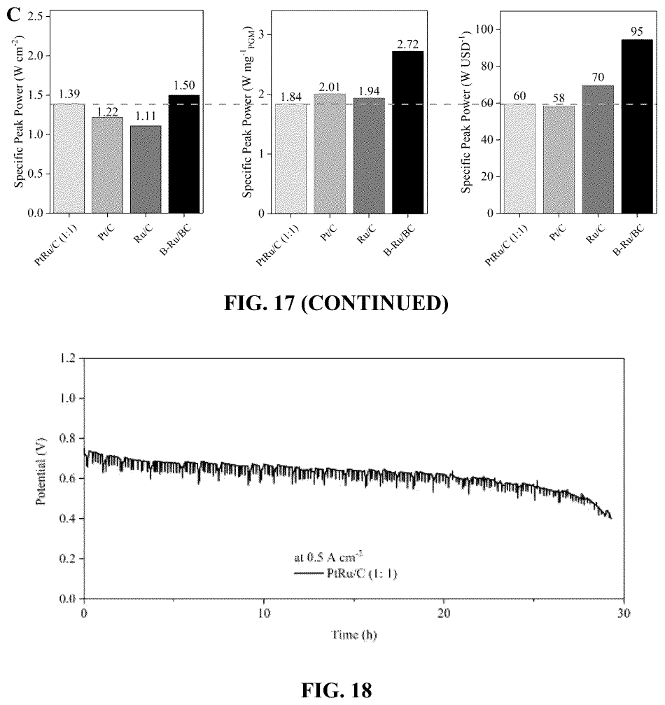

FIG. 17A demonstrates the AEMFC performance using B-Ru/BC or Pt/C as the anode catalyst. The B-Ru/BC anode enabled the cell to reach a peak power density (PPD) of 1.47 W cm⁻² while 1.22 W cm⁻² was obtained by the cell based on a Pt/C anode, which shows that B-Ru/BC performs better than Pt/C in AEMFCs.

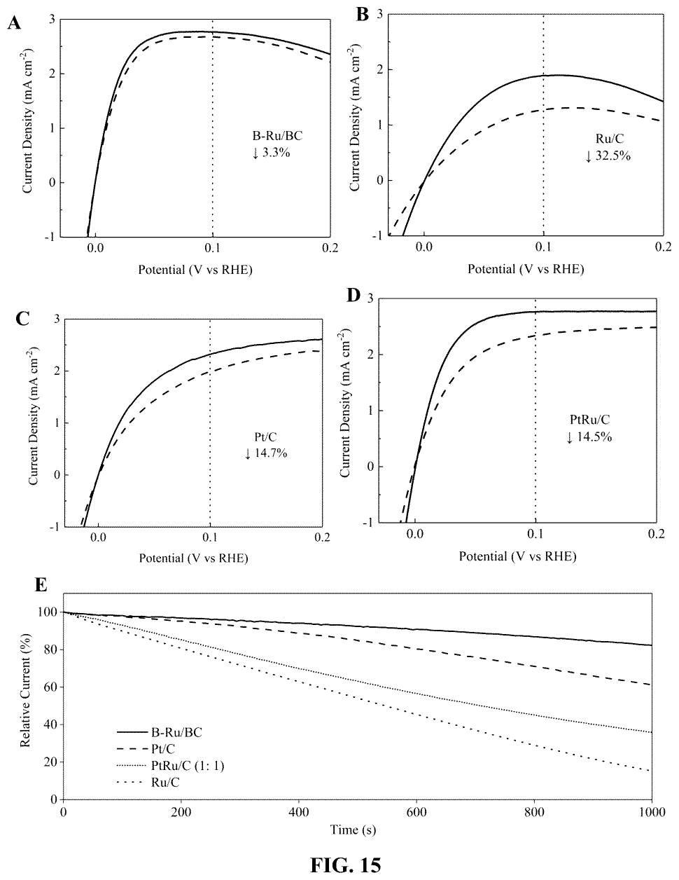

FIG. 15A shows the CO-tolerant performance of B-Ru/BC. The current density for HOR at 0.1 V overpotential decreased by 3.3% in 0.1 M KOH with CO compared to without CO for B-Ru/BC.

FIG. 15C shows the CO-tolerant performance of Pt/C. The current density for HOR at 0.1 V overpotential decreased by 14.7% in 0.1 M KOH with CO compared to without CO for Pt/C, indicating B-Ru/BC possesses higher CO-tolerance than Pt/C.

FIG. 17B shows the durability of AEMFCs using B-Ru/BC or Pt/C anodes. B-Ru/BC-based AEMFC operated for 55 h at a constant current density of 0.5 A cm⁻² without significant potential decrease. The AEMFC based on a Pt/C anode shows observable potential losses after 35 h of operation. It shows that the AEMFC with a B-Ru/BC anode demonstrates better durability than a Pt/C anode.

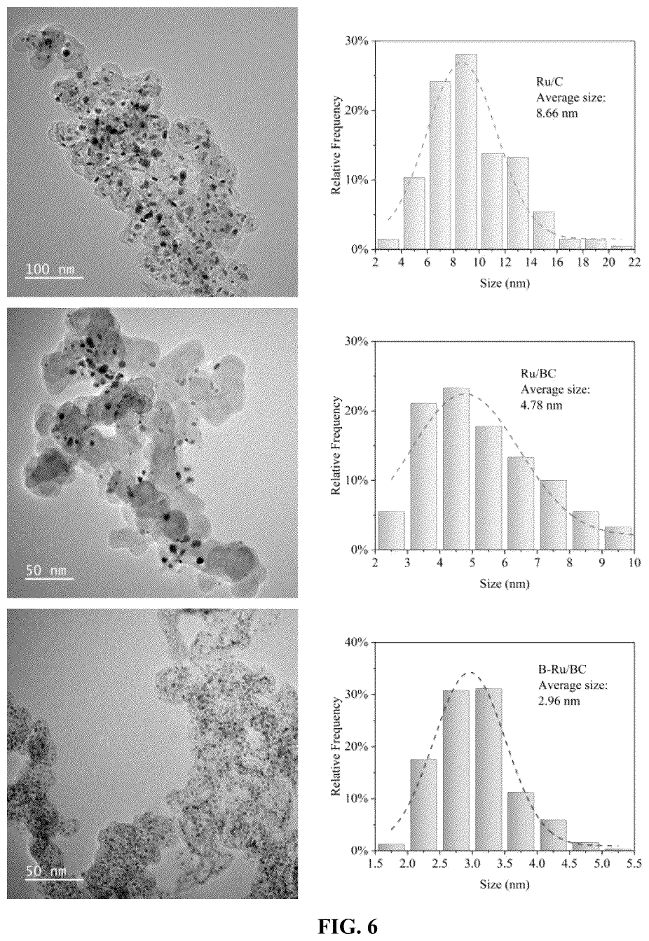

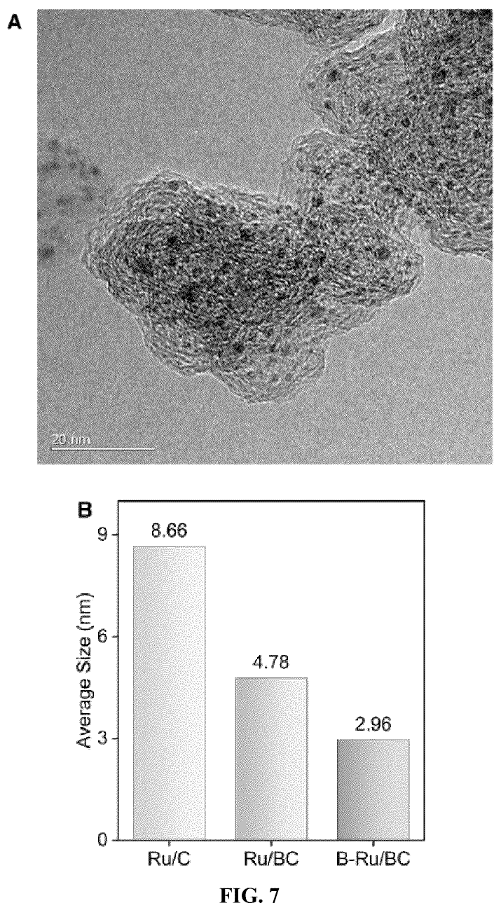

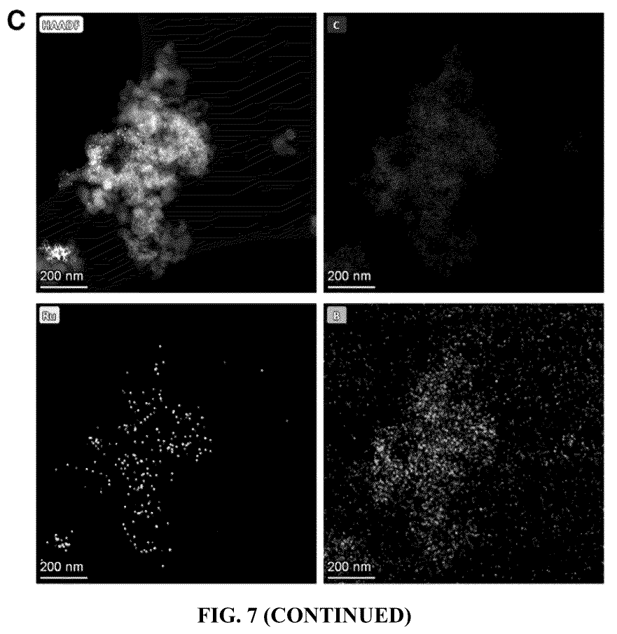

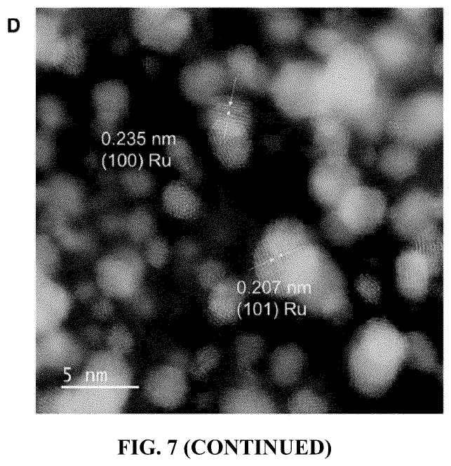

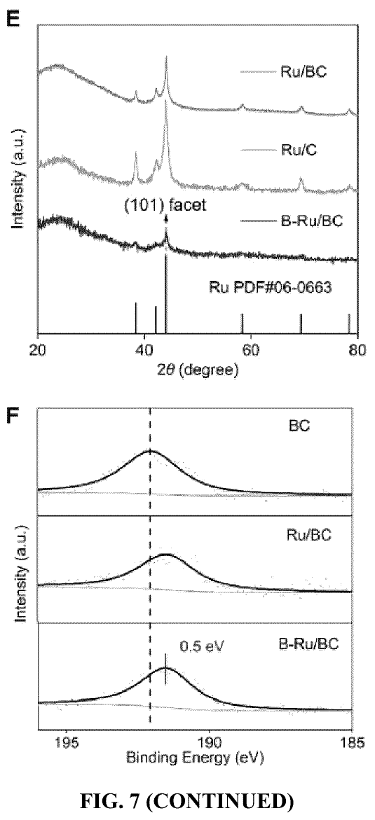

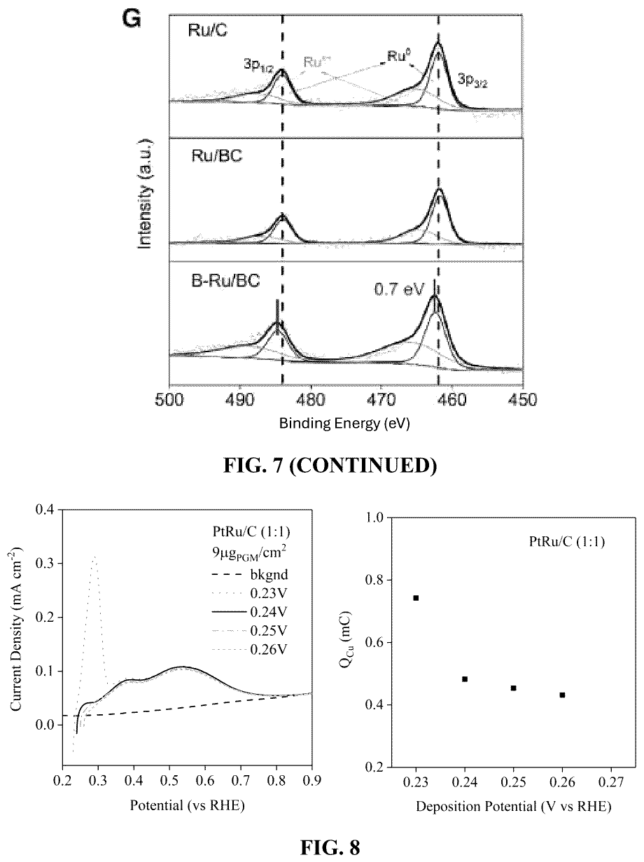

FIG. 5 illustrates the synthesis process for B-Ru/BC samples using a simple impregnation method. The mixture of RuCl₃, H₃BO₃, water, and carbon support was rapidly dried to suppress the aggregation of Ru salts in the precursors. After annealing in Ar at an optimal temperature, Ru nanoparticles with B-doped surface supported on carbon were obtained. Ru/BC and Ru/C were synthesized based on the same process just without adding H₃BO₃, and B-doped carbon, BC, was used instead of carbon to prepare Ru/BC. The TEM images of B-Ru/BC, Ru/BC, and Ru/C were collected, and the particle size distribution was analyzed and presented in FIG. 6. The results show that B-Ru/BC exhibits the smallest average particle size of 2.96 nm and the narrowest size distribution, while Ru/C shows the largest average particle size of 8.66 nm and the widest size distribution. The average particle sizes were summarized in FIG. 7b.

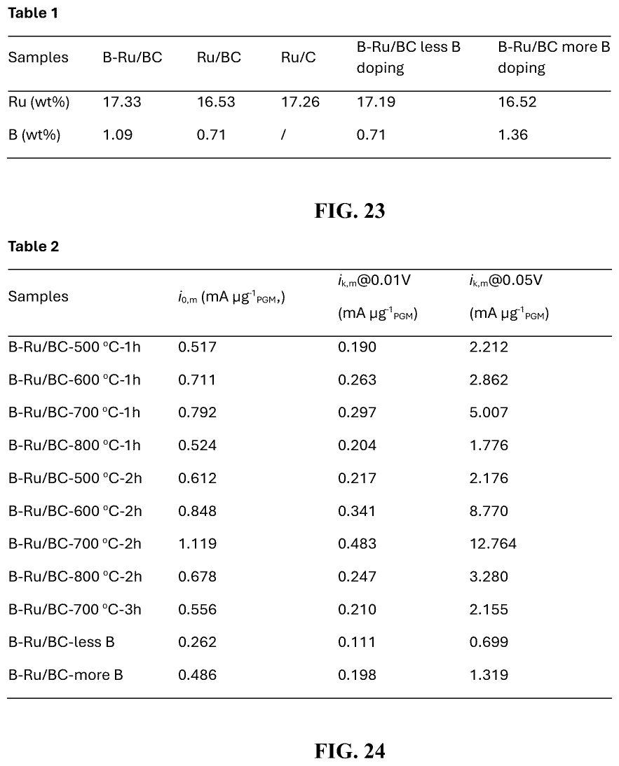

The amplified TEM image in FIG. 7a also demonstrates the uniform distribution of B-Ru nanoparticles on the carbon support. Besides, a B-rich environment is confirmed through EDX elemental mappings (FIG. 7c). Analysis of the lattice fringes (FIG. 7d) reveals dimensions of 0.207 nm and 0.235 nm, corresponding to the (1 0 1) and (1 0 0) facets of the hexagonal close-packed (hcp) Ru phase (PDF card No.: 06-0663), respectively. Additionally, the compositions of B-Ru/BC, Ru/BC, and Ru/C were analyzed using inductively coupled plasma mass spectrometry (ICP-MS), with results summarized in Table 1 (FIG. 23). The findings confirmed that the Ru/BC sample contains B from its BC support. This suggests that the carbon support of B-Ru/BC was also doped with B during synthesis, as BC was prepared using the same method but without the addition of the ruthenium source. Further structural information is obtained from XRD patterns in FIG. 7e. The crystalline structures of Ru/BC and Ru/C are identified as an hcp Ru phase with peaks at 38.4°, 42.2°, 44.0°, 58.3°, and 69.4°, corresponding to the (1 0 0), (0 0 2), (1 0 1), (1 0 2), and (1 1 0) facets (PDF card No.: 06-0663). Notably, there is no peak shift in the XRD patterns of B-Ru/BC, Ru/BC, and Ru/C, implying that B may not diffuse into Ru particles to form ruthenium boride.

The surface chemical states of B-Ru/BC and the control samples (Ru/BC, Ru, and BC) are examined by XPS, as displayed in FIG. 7f-g. In the B 1 s spectra (FIG. 7f), the peaks for B-Ru/BC and Ru/BC are positioned at around 191.5 eV, exhibiting a negative shift of 0.5 eV from that for BC at 192.0 eV. This finding shows that the chemical state of B species is lower in B-Ru/BC and Ru/BC than in BC, indicating an enhanced reduction of B species due to the presence of Ru species during the synthesis. Notably, no signal is observed at around 188 eV for B⁰ of the boride structure, demonstrating that B does not form boride.

In FIG. 7g, the Ru 3p_{1/2} and 3p _{3/2} peaks for B-Ru/BC are located at 484.7 and 462.6 eV, respectively, while those for Ru/BC and Ru/C are found at 484.0 eV and 461.9 eV. As observed, the binding energies of the Ru 3p peaks for Ru/BC remain nearly unchanged compared to those for Ru/C, indicating a limited electron transfer between Ru and B doped in the carbon support. However, the Ru 3p peaks for B-Ru/BC undergo a positive shift of 0.7 eV, suggesting a lower electron density caused by the B on the Ru particle surface but not the B doped in the carbon support. The B doping on the surface of Ru nanoparticles results in a stronger B-Ru interaction, leading to an enhanced electron transfer from Ru to B species in B-Ru/BC compared to Ru/BC. This supports the notion that some B species are directly doped on the Ru particle surface in the B-Ru/BC sample, whose stronger B-Ru interaction enhances the catalytic activity for HOR, as measured subsequently.

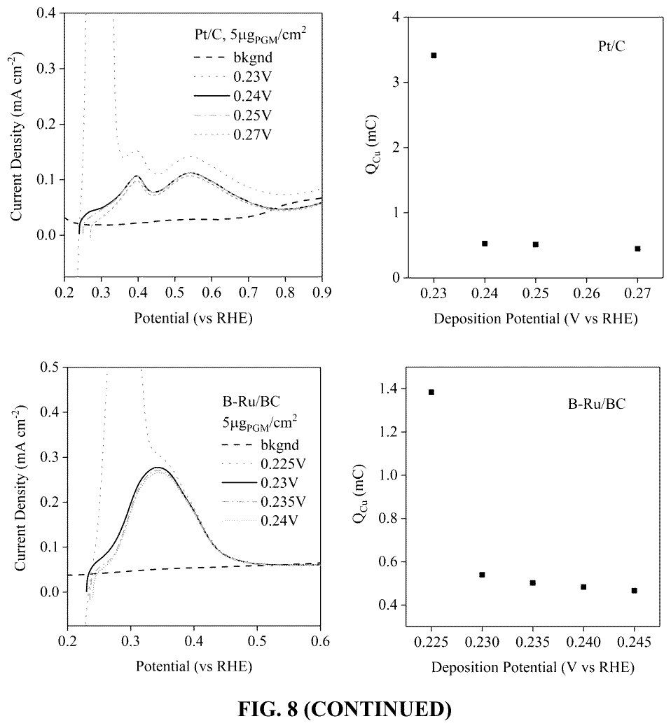

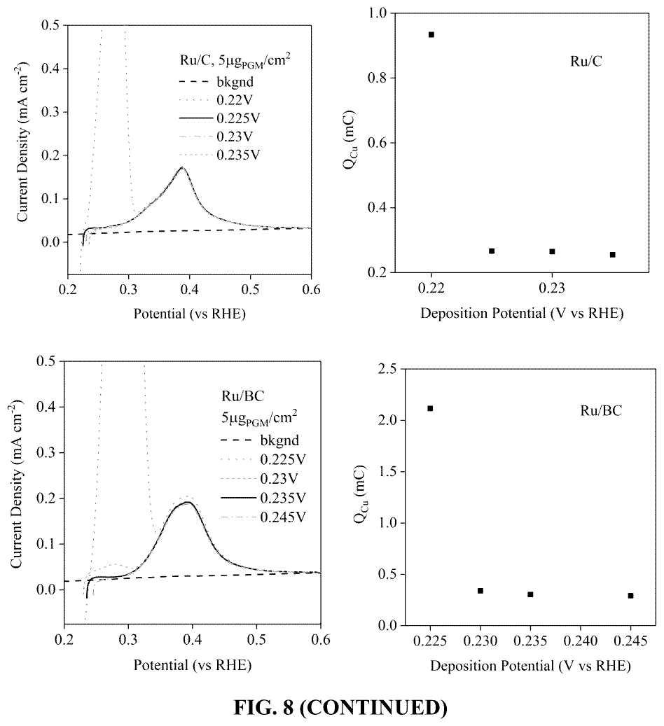

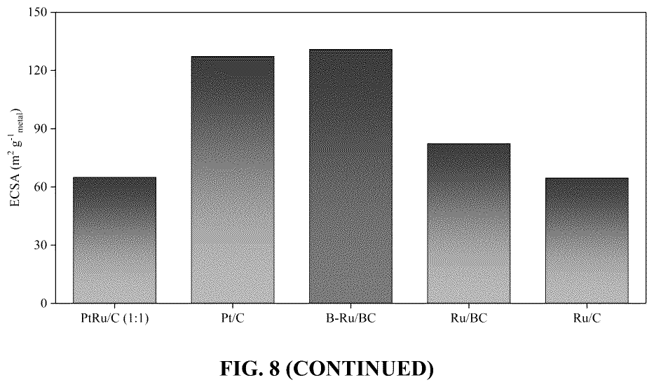

The impressive performance of the B-Ru/BC sample encourages an investigation into the influence of B doping on the electronic structure of Ru, which has been detailed by the XPS analysis. In addition, the TEM images reveal that B-Ru/BC exhibits smaller and more uniformly distributed Ru particle sizes than Ru/C and Ru/BC (seeing FIG. 12). The polarization curves in FIG. 8 indicate that the B-Ru/BC catalyst with a moderate level of B doping, used throughout this manuscript, exhibits higher HOR catalytic activity compared to those with either lower or higher levels of B doping. The TEM images in FIGS. 5 show that the B-Ru/BC samples with less B doping have larger particle sizes, similar to Ru/C in FIG. 6, while the samples with more B doping exhibit smaller particle sizes, akin to the B-Ru/BC in FIG. 6. This can be presumably attributed to the role of boric acid in controlling particle sizes during the synthesis process, which facilitates a more uniform dispersion of ruthenium trichloride on the carbon support in precursor preparation. The ECSA measurements using the Cu_{UDP} method (FIG. 8) reveal an ECSA of 64.6 m² g⁻¹_{Ru} for Ru/C and 130.9 m² g⁻¹_{Ru} for B-Ru/BC. Correspondingly, the i_{0,s} are 0.238 mA cm⁻²_{ECSA} for Ru/C and 0.855 mA cm⁻²_{ECSA} for B-Ru/BC. This threefold increase in i_{0,s} for B-Ru/BC compared to Ru/C indicates that, in addition to particle size control, the utilization of boric acid in precursor preparation also enhances the HOR activity of Ru by optimizing the interaction between B and Ru.

The HOR polarization curves measured at 1600 rpm in H₂-saturated 0.1 M KOH at a scan rate of 10 mV s⁻¹ are displayed in FIGS. 9a, 10 and 11. B-Ru/BC reaches the limiting current at a lower potential than commercial Pt/C and PtRu/C (1:1), indicating a faster reaction kinetics, whereas Ru/C and Ru/BC cannot reach the limiting current due to the sluggish kinetics. The i_{k,m} and the i_{0,m} are derived from the Butler-Volmer fitting. The Tafel plots are presented in FIG. 9b with the fitting curves, which shows the data well fits the Butler-Volmer equation indicating the accuracy and reliability of the calculation results of i_{k,m} and the i_{0,m}.

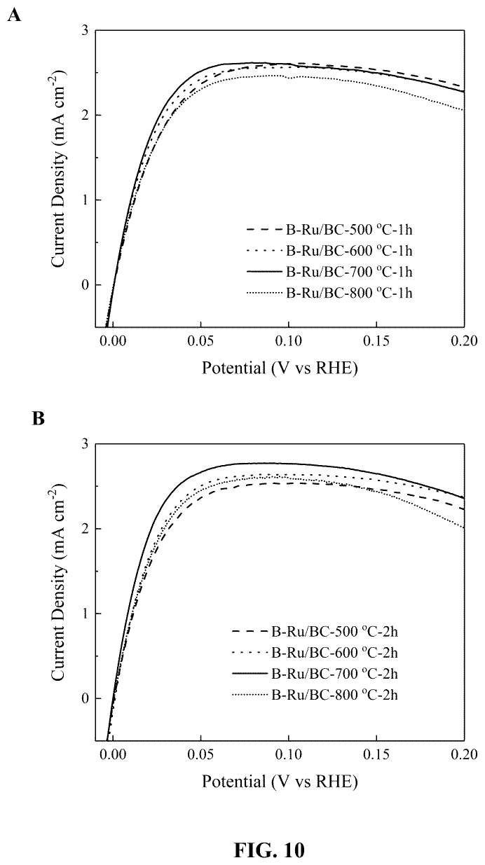

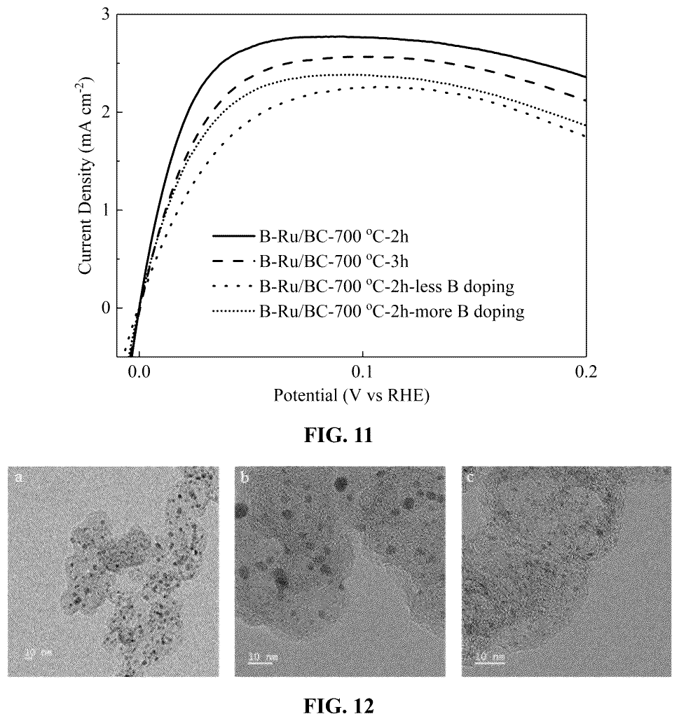

To obtain the optimal performance, B-Ru/BC catalysts were prepared under varying annealing temperatures and time. The HOR performance was assessed and depicted in FIG. 10. The i_{0,m} and i_{k,m} were calculated by the Butler-Volmer fitting and listed in Table 2 (FIG. 24). The B-Ru/BC samples were annealed under various conditions to optimize hydrogen oxidation reaction (HOR) performance, as shown in FIGS. 10 and 11.

The B-Ru/BC sample annealed at 700° C. for 2 hours exhibited better performance than that annealed for 1 hour. However, performance decreased when the annealing time was extended to 3 hours. This decline can be attributed to the larger particle sizes observed in FIG. 12A, which indicate a reduced active surface area. Therefore, the same annealing condition achieving the highest performance for B-Ru/BC was applied to the control samples, including Ru/C and Ru/BC.

The HOR activities of PtRu/C (1:1), a commercial Ru-based catalyst, and commercial Pt/C were measured for comparison. The i_{0,s} was calculated by normalizing i_{0,m} based on ECSA. The results in FIGS. 9c-d demonstrate that the i_{0,s} of B-Ru/BC is 0.855 mA cm⁻²_{ECSA}, which is 3 times those of Ru/C and Pt/C and comparable to that of PtRu/C (1:1), and the mass-normalized exchange current density i_{0,m} reaches 1.119 mA μg⁻¹_{PGM}, 4 times that of Pt/C and even higher than PtRu/C (1:1). Furthermore, the mass activity at a 0.01 V overpotential (i_{k,m}@0.01V) of B-Ru/BC is 0.483 mA μg⁻¹_{PGM} slightly higher than PtRu/C (1:1), and the mass activity at a 0.05 V overpotential (i_{k,m}@0.05V) of B-Ru/BC is 12.764 mA μg⁻¹_{PGM}, which is 36 times, 17 times, and 2 times those of Ru/C, Pt/C, and PtRu/C (1:1), respectively. This indicates that the catalytic performance of B-Ru/BC is similar to that of PtRu/C (1:1) near the HOR equilibrium potential, but B-Ru/BC achieves a much higher mass kinetic activity than PtRu/C (1:1) at an overpotential of 0.05 V. As for the control samples, Ru/C exhibits the lowest i_{0,s} of 0.238 mA cm⁻²_{ECSA,} while Ru/BC shows a higher i_{0,s} of 0.594 mA cm⁻²_{ECSA} than that of commercial Pt/C, attributed to the optimal anchoring effects and strong metal-support interaction facilitated by the doped support. The catalytic activity of B-Ru/BC surpasses that of Ru/BC, suggesting that the surface doping of B plays a significant role in improving the HOR performance of Ru nanoparticles.

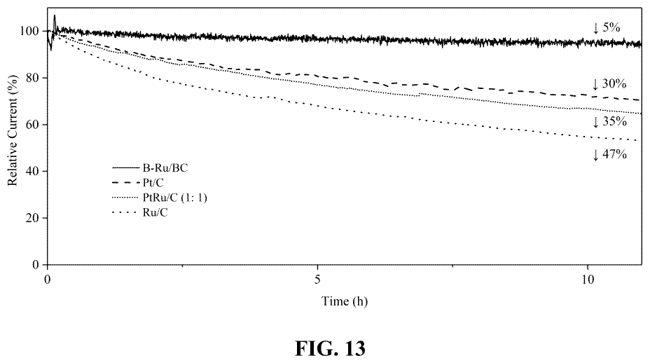

Moreover, the stability of B-Ru/BC was also evaluated by chronoamperometry tests at 0.1 V in H₂-saturated 0.1 M KOH. As shown in FIG. 13, B-Ru/BC exhibits better stability than Pt/C, PtRu/C (1:1) and Ru/C, with only 5% current decrease after 11 hours. The HOR current of commercial Pt/C decreases by 30%, while Ru/C demonstrates the worst stability with 47% of current decline. Interestingly, PtRu/C(1:1) performs similarly to Pt/C in the chronoamperometry test, although it exhibits much higher HOR activity than Pt/C. It could be attributed to the high Ru content in PtRu/C (1:1), which makes PtRu/C (1:1) behave between Pt/C and Ru/C in some aspects such as stability here.

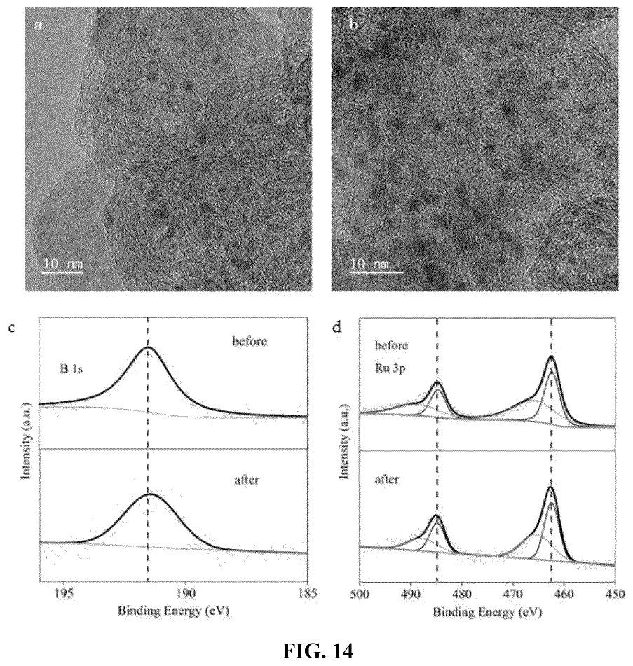

To explore the possible structure changes during the HOR stability test, the TEM images and XPS spectra of the B-Ru/BC-coated carbon paper, both before and after the chronoamperometry tests, were collected. As shown in FIG. 14, no significant shift can be observed in the B 1s peak and Ru 3p_{1/2} and 3p_{3/2} peaks, and the morphology also remains unchanged. It indicates the stable structure of B-Ru/BC catalysts.

Since CO impurities commonly exist in H₂ resources obtained from the catalytic reforming of hydrocarbons, which can lead to CO poisoning and a decrease in activity, it is necessary to assess the CO-tolerance of the catalysts through RDE tests before the application. Consequently, the HOR polarization curves were measured when 1000 ppm of CO was introduced into the electrolyte instead of purging with pure H₂. As shown in FIGS. 15a-d, the current densities at the overpotential of 0.1 V vs RHE decrease by 3.3%, 14.5%, 14.7%, and 32.5% for B-Ru/BC, PtRu/C (1:1), Pt/C, and Ru/C, respectively. It demonstrates that B-Ru/BC displays the highest CO tolerance, even higher than commercial Pt/C and PtRu/C (1:1), while Ru/C is the worst. This strongly reflects the advantages of the B modification.

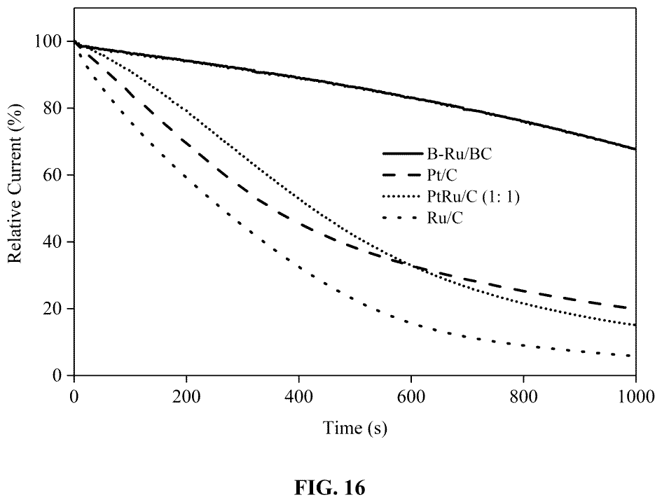

Furthermore, the CO resistance was also characterized by testing the HOR stability of the catalysts under CO poisoning. The CO-tolerant stability was measured at two loadings of 20 μg_{PGM} cm⁻² (FIGS. 15e) and 10 μg_{PGM} cm⁻² (FIG. 16). The HOR current in the RDE test was recorded at 0.1 V vs RHE at 1600 rpm. The results illustrate that B-Ru/BC still demonstrates the best CO resistance over time, regardless of large or small loadings, while Ru/C shows the worst performance. It is also found that a higher catalyst loading contributes to better CO tolerance and higher stability.

To assess the fuel cell performance, B-Ru/BC, Ru/C, and the commercial catalysts were utilized as the anodes in the operational AEMFCs at 95° C. in H₂/O₂. The polarization curves are depicted in FIG. 17a. The PPDs follow the order of B-Ru/BC>PtRu/C (1:1)>Pt/C>Ru/C. It shows that B-Ru/BC performs even better than commercial PtRu/C (1:1), although PtRu/C (1:1) contains more expensive Pt. Specifically, the AEMFC employing the B-Ru/BC anode achieves a PPD of 1.50 W cm⁻², which is one of the highest PPDs using Ru-based anodes reported so far.

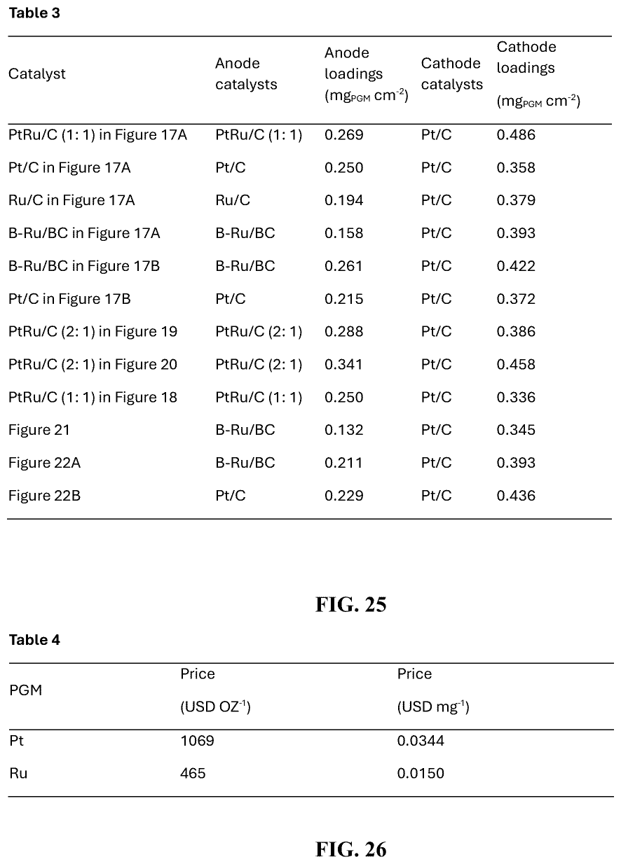

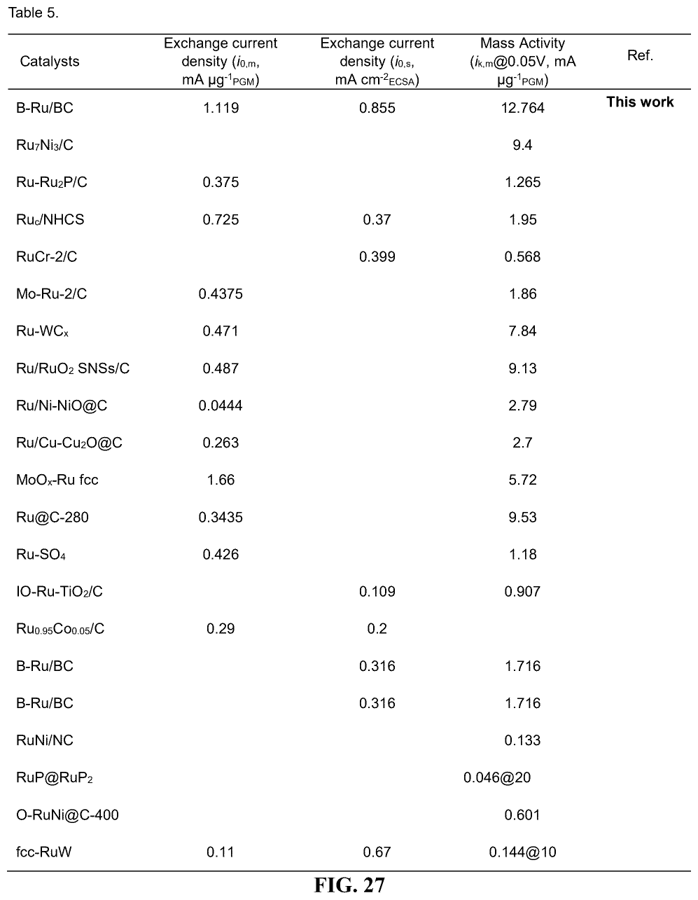

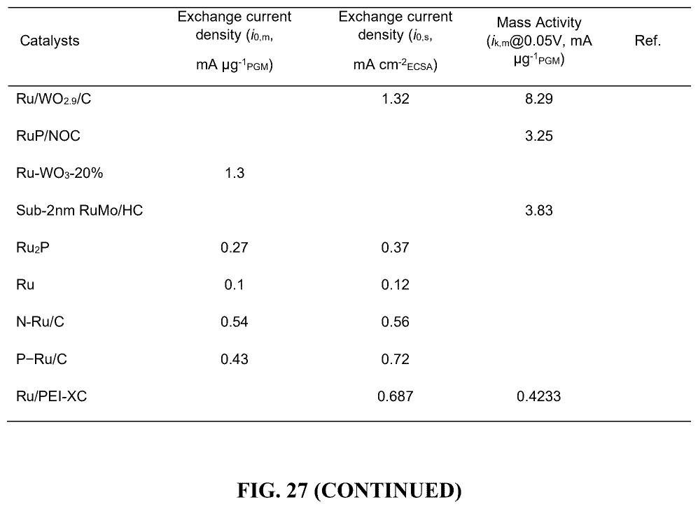

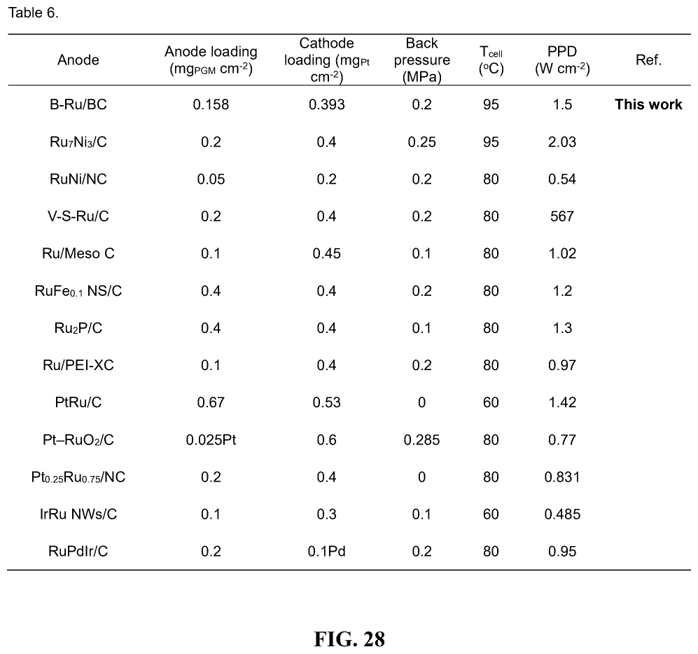

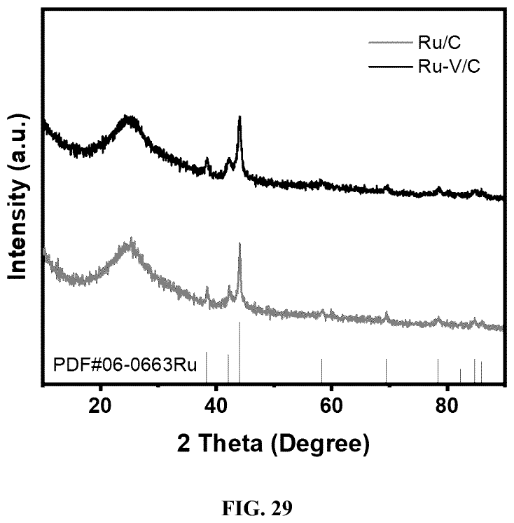

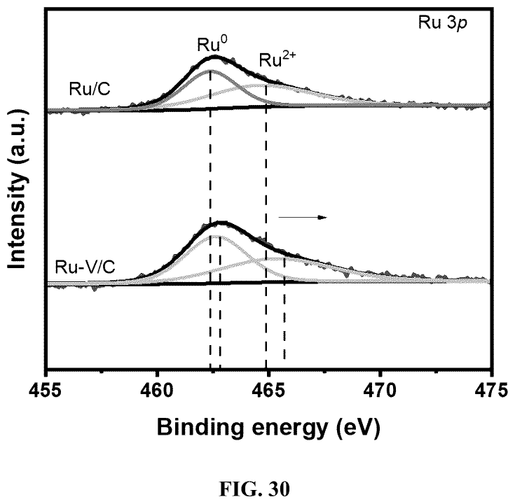

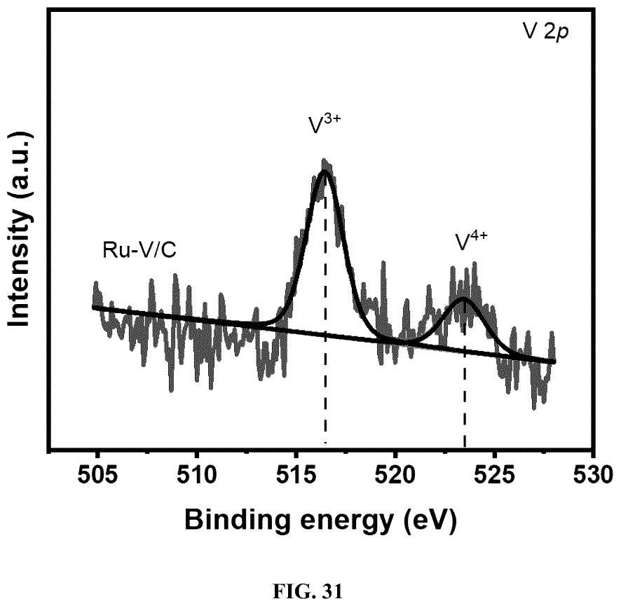

To assess cost-effectiveness, the PPD was converted to the specific peak power (FIG. 17C), based on the anodic and cathodic loadings. Since the catalyst layers were hand-sprayed, the loadings typically vary within a certain range, which were carefully measured for all cases as listed in Table 3 (FIG. 25). As well, the recent PGM prices for calculating the specific peak power are listed in Table 4 (FIG. 26). It is revealed that the AEMFC utilizing the B-Ru/BC anode achieves a notably higher specific peak power of 2.72 W mg⁻¹_{PGM} or 95 W USD⁻¹ compared to all other cells, indicating the highest cost efficiency.

In addition, the fuel cell durability was also evaluated, as depicted in FIG. 17B. When operating at a constant current density of 0.5 A cm⁻², the potential of the B-Ru/BC-based AEMFC does not significantly decrease over 55 hours, whereas the potential of the Pt/C-based cell declines rapidly after 40 hours of operation. The potential of the B-Ru/BC-based cell exhibits a larger fluctuation than that of the Pt/C-based cell due to more pronounced flooding. This can be attributed to the thicker B-Ru/BC catalyst layer compared to the Pt/C layer, resulting from the significantly lower Ru content (FIG. 23, Table 1) than the Pt content (47.1%, TANAKA Kikinzoku Kogyo). However, the PtRu/C (1:1) displays lower durability than Pt/C not only in the half cell (FIG. 13) but also in the AEMFC. FIG. 18 shows that the potential of the AEMFC using a PtRu/C (1:1) anode declined rapidly after 20 hours and the cell died in 30 hours. It can be concluded that the AEMFC with the B-Ru/BC anode demonstrates superior durability, with a limited voltage drop rate of 0.85 mV h⁻¹, compared to those with Pt/C and PtRu/C (1:1).

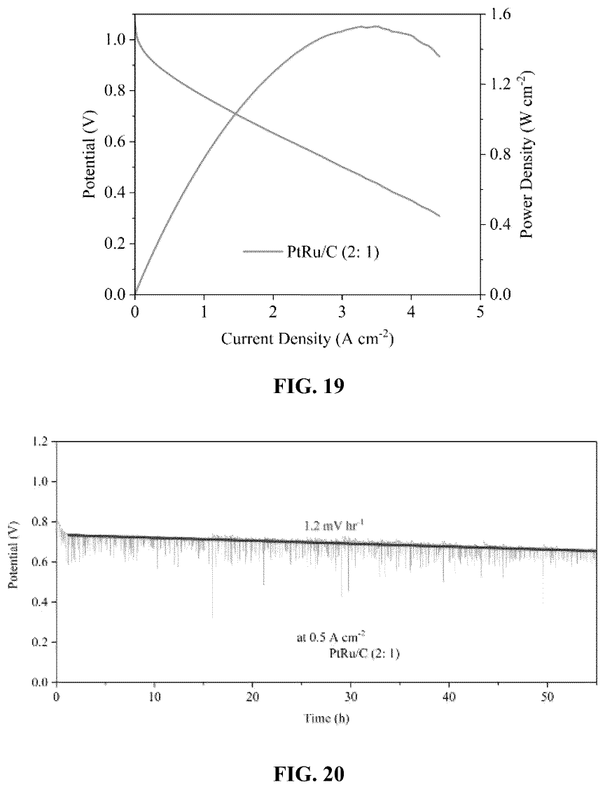

Furthermore, another commercial PtRu/C (27 wt % Pt, 13 wt % Ru on Vulcan XC 72R, Fuel Cell Earth, denoted as PtRu/C (2:1)), was also adopted to compare with B-Ru/BC in this work. Generally, PtRu/C (2:1) with higher Pt content than PtRu/C (1:1) performs higher HOR activities. As expected, the PtRu/C (2:1) anode enables the AEMFC to reach a higher PPD of 1.53 W cm-2 (FIG. 19) than the PtRu/C (1:1) anode. Impressively, the PPD of 1.50 W cm⁻² reached by the B-Ru/BC anode is very close to that achieved by the PtRu/C (2:1) anode.

As well, the AEMFC durability using the PtRu/C (2:1) anode was evaluated, as depicted in FIG. 20. It displays outstanding durability with a small voltage drop rate of 1.2 mV h⁻¹. Impressively, the B-Ru/BC anode performs a little better than the PtRu/C (2:1) anode on the AEMFC durability with a smaller voltage drop rate of 0.85 mV h⁻¹.

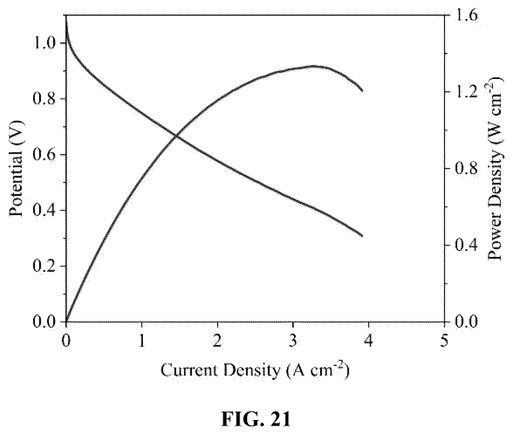

To highlight the advantages of this B-Ru/BC anode, an AEMFC was assembled using the B-Ru/BC anode with the lowest loading of 0.132 mg_{PGM} cm⁻² and a Pt/C cathode with the lowest loading of 0.345 mg_{PGM} cm⁻² among all the cells tested in FIG. 17a. Remarkably, this cell achieved a PPD of 1.34 W cm⁻² (FIG. 21), surpassing cells that utilized either the Pt/C or Ru/C anodes. This performance is very close to the 1.38 W cm⁻² achieved with a commercial PtRu/C (1:1) anode that has twice the PGM loading. Since the catalyst layers were hand-sprayed, the loadings typically vary within a certain range. These loadings were carefully measured for all cases and are detailed in Table 3 (FIG. 25).

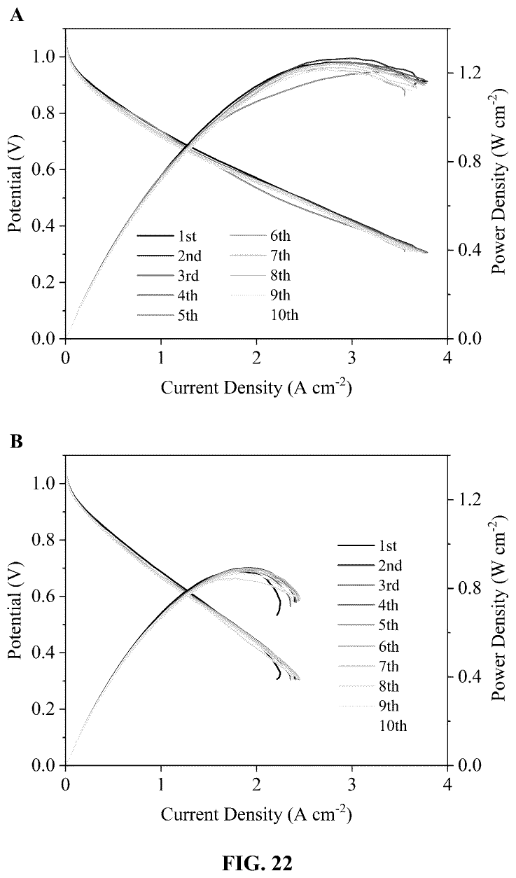

Moreover, the AEMFC polarization curves for the first 10 cycles at a cell temperature of 80° C. using the B-Ru/BC anode are presented in FIG. 22, alongside those using the Pt/C anode for comparison. Both cells exhibit good stability, showing only a limited decline in performance after 10 cycles.

Overall, B-Ru/BC outperforms Pt/C and PtRu/C (1:1) when used as the anode in AEMFCs in terms of both performance and durability. More than that, the AEMFC with the B-Ru/BC anode demonstrates comparable performance and durability to that with the PtRu/C (2:1) anode.

### EXAMPLES

### Example 1—Preparation of Ru-V/C Electrocatalyst

Ammonium metavanadate (20 mg) was dissolved in of deionized water (50 mL) in a beaker to give a first solution. Ruthenium (III) chloride (50 mg) was dissolved in the first solution to give a second solution. Vulcan carbon (100 mg) was added to the second solution to give a first suspension. The first suspension was sonicated in a water bath for 30 min and then dried at 60° C. with stirring to remove the solvent and give a powder. The powder was treated with H₂/Ar (6.98% V/V) gas at 500° C. for 2 h to reduce the powder and form the Ru-V/C electrocatalyst.

### Example 2—Electrochemical Tests of Ru-V/C Electrocatalyst

The HOR evaluation was carried out in a Teflon cell using a standard three-electrode set-up equipped with an electrochemical workstation (CHI760e). Catalyst (2.5 mg) was added to a solvent mixture of deionized water and isopropyl alcohol (1.25 mL; v/v 1:4), along with an additional of 5% w/v Nafion™ solution (10 μL). After sonication for 20 minutes, the resulting ink (10 μL) was dispersed onto a rotating disc electrode (RDE) to prepare a working electrode with a diameter of 5 mm, producing around 10 μg_{Ru} cm⁻2 loading.

For comparison, the commercial Pt/C (47.1 wt %, Tanaka Kikinzoku Kogyo K. K) was prepared with the same metal loading of 10 μg_{Pt} cm⁻².

Before test, the working electrode was applied cyclic voltammogram (CV) in Ar-saturated 0.1 M KOH solution from 0.03 V to 0.7 V for 10 cycles with carbon rod and Hg/HgO as the counter and reference electrodes, respectively. Linear sweep voltammetry (LSV) was conducted in H₂-saturated 0.1 M KOH at 1600 rpm rotation from −0.1 to 0.3 V with a scan rate of 10 mV s⁻¹. All reported potential values are in reference to a reversible hydrogen electrode (RHE) unless otherwise specified. Ohmic losses were compensated by deducting the ohmic voltage drop from the measured potential using the electrolyte resistance obtained from electrochemical impedance spectroscopy (EIS) ranging from 100 kHz to 1 Hz with a voltage perturbation of 5 mV.

### Example 3—Ru-V/C Electrocatalyst Fuel Cell Test

The ink was prepared by adding the catalyst into deionized water, isopropyl alcohol, 5% ionomer solution (PiperION), and sonicating in an ice bath for 1 hour. The resulting ink was sprayed onto both sides of a 20 um PiperION membrane with a 5 cm²area to create a catalyst-coated membrane (CCM). The anode metal loading was kept at 0.1 mg cm⁻² for both V-Ru/C-0.6 and the comparative sample PtRu/C (58 wt %, Tanaka Kikinzoku Kogyo K. K). And the cathode Pt loading was 0.4 mg cm⁻² for Pt/C (47.1 wt %, Tanaka Kikinzoku Kogyo K. K). Before testing, the prepared CCM was ion exchanged in 1 M KOH (refreshed every 20 minutes) for 1 hour. The resulting CCM was rinsed with deionized water to remove alkaline residuals. Subsequently, it was assembled between two pieces of carbon papers (Sigracet® 22BB), gaskets, graphite bipolar plates, and metal current collectors to complete the full AEMFC. The H₂-O₂ fuel cells were tested using a Fuel Cell Technology test station. The cell temperature was set at 80° C. while the H₂ and O₂ gases were humidified at temperatures of 78° C. and 80° C., respectively. Both H₂ and O₂ were supplied at flow rates of 1000 sccm, and a back pressure of 200 kPa was applied on both sides of the cell. Experimental results are shown in FIG. 3.

### Example 4—Preparation of B-Ru/BC Catalyst

The B-Ru/BC catalysts were synthesized using the wet impregnation method outlined in FIG. 5. To minimize environmental impacts and reduce costs, organic compounds were avoided with water as the only solvent. Boric acid (H₃BO₃) and RuCl₃·xH₂O served as the boron and ruthenium sources, respectively. RuCl₃·xH₂O (20 mg) was dissolved in ultrapure water (1.5 mL), and H₃BO₃ (70 mg) was dissolved in water (3.5 mL). The RuCl₃ solution (1.5 mL) was mixed with the H₃BO₃ solution (3.5 mL). Meanwhile, carbon black (30 mg) was dispersed in ultrapure water (4 mL) through ice-bath ultrasonication, followed by a dropwise addition of the mixed solution to the carbon suspension under continuous stirring. The resulting suspension was dried for 25 min at 80-90° C. under stirring and blowing to obtain the precursors in powder. These precursors were subsequently annealed at 700° C. in an Ar atmosphere for 2 hours. After washing with water to remove impurities, the B-Ru/BC samples were dried for testing. When preparing the B-Ru/BC samples with less and more B doping, the amounts of H₃BO₃ were 17.5 mg and 140 mg, respectively. Similar methods were used to prepare Ru nanoparticles supported on boron-doped carbon (Ru/BC) and Ru supported on carbon (Ru/C), with the only difference being the absence of boric acid. The B-doped carbon black (BC) was prepared using a similar procedure but without RuCl₃ solution and annealed at 900° C. instead.

### Example 5—Electrochemical Measurements of B-Ru/BC Catalyst

Electrochemical measurements were conducted using a standard three-electrode system controlled by a CHI 760E workstation (CH Instruments, Inc.). The reference electrode was Hg/HgO, and the counter electrode was a graphite rod. The electrolyte was 0.1 M potassium hydroxide (KOH) solution, prepared by dissolving potassium hydroxide sheets from Aladdin in ultrapure water. To prepare the working electrodes, 2 mg of the samples were dispersed in a solution of water and 2-propanol (IPA) through ice-bath sonication. Nafion™ 117 solution (˜5%) was added to the mixture, with the Nafion amount kept under 20 wt % of the catalysts. A certain amount of ink was then dropped on a RDE to fully cover the glassy carbon area. After drying under a daylight lamp, the catalysts were deposited on the RDE at a loading of 10 μg_{PGM} cm⁻² to serve as the working electrodes. For chronoamperometry tests, the working electrodes were prepared by depositing the catalyst inks on carbon paper (Sigracet® 22BB, 5 wt % polytetrafluoroethylene (PTFE) treated) at a loading of 20 μg_{PGM} cm⁻2 and were tested at 0.1 V in an H₂-saturated 0.1 M KOH solution.

Prior to assessing the catalytic activity, polarization curves were collected in the range of −0.05 to 0.7 V vs the reversible hydrogen electrode (RHE) at a scan rate of 0.01 V s⁻¹ with an RDE rotation speed of 1600 rpm in a 0.1 M KOH solution saturated with H₂. An iR compensation of 85% was applied during testing, and the remaining 15% was compensated during data processing. The ohmic resistance was measured using Electrochemical Impedance Spectroscopy (EIS). To evaluate the catalysis activities, the i₀ was obtained by fitting the calculated kinetic current density (iₖ) to the Butler-Volmer equation

$$i k = i 0 [ e α FRT η - e - ( 1 - α ) FRT η ] ik = i 0 e α FRT η - e - 1 - α FRT η$$

where α, η, R, T and F are the transfer coefficient, overpotential, gas constant 8.314 J mol⁻¹ K⁻¹, temperature in Kelvin unit and Faraday's constant. iₖ can be calculated from the Koutecky-Levich equation

$$1 i = 1 ik + 1 id 1 i = 1 ik + 1 id$$

where i_{d} is H₂ diffusion-limited current density, and i is the current density measured. Usually, i_{d} was derived from the following equation

$$η diffusion = - R T 2 F ln ( 1 - idi lim ) η diffusion = - RT 2 F ln 1 - idi lim$$

where η_{diffusion} and iₗᵢₘ are diffusion-controlled overpotential and H₂-limiting current density, respectively. Finally, the i₀ can be obtained based on the above deviation.

An under-potential deposition (UPD) stripping method known as Cu-UPD was utilized to assess the ECSA of the catalysts. First, the catalysts on an RDE were cleaned by cycling between 0.05 and 0.7 V vs RHE at a scan rate of 0.1 Vs⁻¹ in an Ar-saturated 0.5 M sulfuric acid (H₂SO₄) solution. Subsequently, the UPD of a Cu monolayer was conducted by immersing the CV-cleaned electrode in a 0.5 M H₂SO₄ solution containing 5 mM CuSO₄ (copper (II) sulfate pentahydrate) solution for 100 seconds at an optimized potential. A linear sweep voltammetry (LSV) analysis was then performed on this Cu-deposited electrode, scanning from the optimized potential to 0.7 V vs RHE at a scan rate of 0.01 V s⁻¹. The background LSV curve was obtained by scanning the same electrode without Cu deposition in a 0.5 M H₂SO₄ solution. The corrected charge for the Cu-UPD stripping was determined as the charge difference between the stripping LSV and the background LSV. The ECSA was subsequently calculated using a stripping charge of 420 μC cm⁻².

For the CO tolerance tests, polarization curves were measured using the same method as the HOR activity measurement with RDEs, but the electrolyte was saturated with H₂ containing 1000 ppm CO. Stability tests were conducted under the same conditions, but the electrodes were held at 0.1 V vs RHE. All electrochemical experiments were performed at room temperature.

### Example 6—MEA Fabrication and Fuel Cell Testing

The membrane electrode assemblies (MEAs) were fabricated using the catalyst-coated membrane (CCM) method. The CCMs were created by applying the catalyst inks onto the self-supporting PiperION film (20 μm, ion exchange capacity (IEC)˜2.35 meq/g, Versogen) with an active area of 5 cm² using an Iwata spray gun with air as the carrier gas. The coating layer was left to dry naturally at room temperature. The target PGM loading was 0.2 mg_{PGM} cm⁻² and 0.4 mg_{Pt} cm⁻² for anodes and cathodes, respectively. The inks contained catalysts, ionomers, and solvents. As the catalysts were PGM-based with high catalytic activities, 50 μL of ultrapure water was added to a certain amount of catalysts to prevent oxidation catalysis when adding 1 mL of IPA. After 20 min sonication, the anion exchange ionomer (AEI), PiperION-A5-HCO₃-EtOH dispersion (5 wt % in ethanol, Versogen), was added, and the inks were continuously sonicated in the ice bath for at least 1 hour to ensure uniform dispersion of all the components.

The CCMs underwent an anion exchange in a 1 M NaOH solution at room temperature for 3 hours, with the solution being refreshed every hour. Subsequently, the CCMs were transferred to deionized water (DIW) to eliminate excess NaOH. To assemble the cell, PTFE gaskets with a thickness of 150 μm were utilized on both the anode and cathode sides to achieve a compression ratio of approximately 25%. The gas diffusion layers (GDLs) used were Sigracet® 22 BB, and the tests were conducted using a Fuel Cell Tech. Station. Prior to the performance tests, the cell underwent a break-in process by maintaining a constant current, which was gradually increased from 0 to 7 A at an increment of 1 A. The polarization curves were obtained at a voltage scan rate of 0.01 V s⁻¹. For cell performance testing, the anode and cathode dew points were set at 90° C. and 97° C., respectively, and the cell temperature was maintained at 95° C., all controlled by the fuel cell station. The flow rates were set at 1 L min⁻¹ for H₂ and 2 L min⁻¹ for O₂ at a back pressure of 0.25 MPa. The durability tests were carried out at a cell temperature of 80° C. under a back pressure of 0.15 MPa. The voltage was recorded at a constant current density of 0.5 A cm⁻². H₂ at a flow rate of 0.5 L min⁻¹ was introduced at 79° C., and CO₂-free air (CO₂<or =2 vpm) at a flow rate of 0.5 L min⁻¹ was introduced at 80° C.

What is claimed is:

1. A catalyst comprising ruthenium and boron disposed on a surface of a boron-doped carbon support, wherein the catalyst does not comprise B⁰.

2. The catalyst of claim 1, wherein boron is present in the catalyst at 0.71-1.36 wt % relative to a total weight of the catalyst.

3. The catalyst of claim 1, wherein ruthenium is present in the catalyst at 16-18 wt % relative to a total weight of the catalyst.

4. The catalyst of claim 1, wherein the ruthenium has a hexagonal close-packed (hcp) phase.

5. The catalyst of claim 1, wherein the catalyst has an average particle size of 2-4.5 nm.

6. The catalyst of claim 1, wherein the catalyst is prepared according to a method comprising: providing a mixture of RuY₃, H₃BO₃, and a carbon support, wherein Y for each instance is independently a halide, nitrate, phosphate, sulfate, carbonate, or acetate; and annealing the mixture at 500-900° C. thereby forming the catalyst.

7. The catalyst of claim 5, wherein the mixture is annealed at about 700° C. for about 1 to about 3 hours.

8. The catalyst of claim 1, wherein boron is present in the catalyst at about 1.09 wt % relative to a total weight of ruthenium, boron, and boron-doped carbon support;
ruthenium is present in the catalyst at about 17.33 wt % relative to a total weight of the catalyst; the ruthenium has a hexagonal close-packed (hcp) phase; the catalyst has an average diameter of 2-4.5 nm; the catalyst is prepared according to a method comprising: providing a mixture of RuCl₃, H₃BO₃, and a carbon support; and annealing the mixture at about 700° C. for about 1 to about 3 hours thereby forming the catalyst.

9. An electrode comprising a base electrode or a substrate, wherein the catalyst of claim 1 is disposed on a surface of the base electrode or the substrate.

10. An electrochemical cell comprising: the electrode of claim 9; a counter electrode; and an alkaline electrolyte solution comprising an electrolyte, wherein the electrolyte solution is between and in contact with the electrode and the counter electrode.

11. The electrochemical cell of claim 10 further comprising an anion exchange membrane disposed between the electrode and the counter electrode.

12. A method for generating electricity, the method comprising: introducing a fuel and an oxidant into the alkaline electrolyte solution of the electrochemical cell of claim 10 so as to cause the oxidation of the fuel by the oxidation and thereby generating electricity.

13. The method of claim 12, wherein the fuel comprises hydrogen and the oxidant comprises oxygen.

14. A catalyst comprising ruthenium and VOx disposed on a surface of a carbon support, wherein x is 3-4.

15. The catalyst of claim 14, wherein ruthenium is present in the catalyst at 8-12 wt % relative to a total weight of the catalyst.

16. The catalyst of claim 14, wherein vanadium is present in the catalyst at 0.1-2.0 wt % relative to a total weight of the catalyst.

17. The catalyst of claim 14, wherein the catalyst has an average particle size of about 1.7 nm.

18. The catalyst of claim 14, wherein the catalyst is prepared according to a method comprising: providing a mixture comprising RuY₃, MVO₃, and the carbon support, wherein Y for each instance is independently a halide, nitrate, phosphate, sulfate, carbonate, or acetate, and M is an ammonium, lithium, sodium, or potassium; contacting the mixture with hydrogen gas at 400-600° C. thereby reducing the mixture and forming the catalyst.

19. The catalyst of claim 14, wherein ruthenium is present in the catalyst at 8-12 wt % relative to a total weight of the catalyst; vanadium is present in the catalyst at 0.1-2.0 wt % relative to a total weight of the catalyst; and the catalyst is prepared according to a method comprising: providing a mixture comprising RuY₃, NH₄VO₃, and the carbon support; and contacting the mixture with hydrogen gas at 400-600° C. thereby reducing the mixture and forming the catalyst.

20. An electrode comprising a base electrode or a substrate, wherein the catalyst of claim 14 is disposed on a surface of the base electrode or the substrate.

21. An electrochemical cell comprising: the electrode of claim 20; a counter electrode;
and an alkaline electrolyte solution comprising an electrolyte, wherein the electrolyte solution is between and in contact with the electrode and the counter electrode.

22. The electrochemical cell of claim 21 further comprising an anion exchange membrane disposed between the electrode and the counter electrode.

23. A method for generating electricity, the method comprising: introducing a fuel and an oxidant into the alkaline electrolyte solution of the electrochemical cell of claim 21 so as to cause the oxidation of the fuel by the oxidation and thereby generating electricity.

24. The method of claim 23, wherein the fuel comprises hydrogen and the oxidant comprises oxygen.
